(19) United States
(12) Patent Application Publication
(10) Pub. No.: US 2014/0337192 A1
(43) Pub. Date: Nov. 13, 2014

(54) METHOD AND APPARATUS FOR FACILITATING AN IPR MARKET

(71) Applicants: Ullrich Benjamin Fechner, Gruenwald (DE); Benjamin Kuehn, Goettingen (DE)

(72) Inventors: Ullrich Benjamin Fechner, Gruenwald (DE); Benjamin Kuehn, Goettingen (DE)

(21) Appl. No.: 13/891,962

(22) Filed: May 10, 2013

(51) Int. Cl. G06Q 50/18

(52) U.S. Cl. CPC G06Q 50/184; G06Q 40/04
USPC 705/37

(57) ABSTRACT

A method is disclosed for establishing communication in a network between a seller of intellectual property rights (IPR) using a first node at a first address, and a buyer of IPRs using a second node at a second address. The method uses a third node at a third address to provide IPR data, IPR attribute information, and a first address associated with the identifier. The method determines a criterion to pre-select a set of identifiers; uses attribute information to pre-select a set of identifiers, transmits the pre-selected set of identifiers and associated first addresses from the third node to said second node. The method can fine-select an identifier and generate a message for transmission from the second node to the first address. The message can include the identifier and the second address. A computer-readable medium with instructions and an apparatus to establish communication are disclosed.

### CROSS-REFERENCE TO RELATED APPLICATIONS

This application is entitled to the benefit of Provisional Patent Application Ser. No. 61/645,545, filed May 10, 2012.

### BACKGROUND

### Field of the Invention

These days, there are millions of patents that were granted in the US and even in emerging market countries outside the US. patents do not live forever. Due to its limited lifetime, a patent brings about a decision that cannot be avoided, i.e., when to part with the patent. Not for all patents it is best to wait for expiration of the patent after its maximum lifetime is completed. The owner may simply drop the patent before the patent's end of life.

However, not for every patent holder the best point in time to part with the patent will be same. The owner may also sell the patent to a buyer who attaches a higher value to the patent than the present owner. For example, the non practicing entity may be in a better position to extract future revenue from the patent than a present owner who is engaged in manufacturing and selling products, and who, as a consequence, has to consider customers' and other people's interests. As a consequence, a present owner of a patent, who does not attach sufficient value to the patent to justify the cost of maintenance of the patent, may be able to find a third person who attaches a higher value to the patent than the present owner. Both sides could have an opportunity to improve their situation by assigning the patent right, in particular, as part of a sales or license agreement. However, the costs of finding a suitable buyer can be large. A broker may be involved who takes a cut in the sales price that reflects the value of time taken to identify deal opportunities. As far as “ordinary” patents are concerned, the cut is too large leaving too little to the owner. As a result, probably most deal opportunities never see the light of day.

Many companies need patents—for various reasons such as to enter a patent pool or as a defensive means to gather competitors' respect—but do not have them. In some situations, for example, where the company wishes to “go public” in order to obtain finance, generation of patent assets may take time that the company cannot wait. Such a company then is a potential buyer of other people's patents. Currently, a potential buyer will turn to patent brokers who—as explained above—offer a limited number of patents typically at a high price. Very rarely a potential buyer will directly approach a patent owner, and almost never such approach takes place for any patent that the owner intends to sell. So most patent needs stay unfulfilled.

Broker services have attempted to develop a market for intangibles, however, with little success. Typically, information asymmetry between seller, or its broker, and potential buyer, and even any suspicion of such asymmetry to the disadvantage of the potential buyer, have been a hindrance to development of the market for intangibles.

Tangible goods are commonly sold using the Internet. The Internet comprises a vast number of computers and computer networks that are interconnected through communication links. The interconnected computers exchange information using various services, such as electronic mail, and the World Wide Web (“WWW”). The WWW service allows a server computer system (i.e., Web server or Web site) to send graphical Web pages of information to a remote client computer system. The remote client computer system can then display the Web pages. Each resource (e.g., computer or Web page) of the WWW is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that effects the requesting of Web pages and the displaying of Web pages.

Currently, Web pages are typically defined using HyperText Markup Language (“HTML”). HTML provides a standard set of tags that define how a Web page is to be displayed. When a user indicates to the browser to display a Web page, the browser sends a request to the server computer system to transfer to the client computer system an HTML document that defines the Web page. When the requested HTML document is received by the client computer system, the browser displays the Web page as defined by the HTML document. The HTML document contains various tags that control the displaying of text, graphics, controls, and other features. The HTML document may contain URLs of other Web pages available on that server computer system or other server computer systems.

The World Wide Web is especially conducive to conducting electronic commerce. Many Web servers have been developed through which vendors can advertise and sell product. The products can include items (e.g., music) that are delivered electronically to the purchaser over the Internet and items (e.g., books) that are delivered through conventional distribution channels (e.g., a common carrier). A server computer system may provide an electronic version of a catalog that lists the items that are available. A user, who is a potential purchaser, may browse through the catalog using a browser and select various items that are to be purchased. When the user has completed selecting the items to be purchased, the server computer system then prompts the user for information to complete the ordering of the items. This purchaser-specific order information may include the purchaser's name, the purchaser's credit card number, and a shipping address for the order. The server computer system then typically confirms the order by sending a confirming Web page to the client computer system and schedules shipment of the items.

The success of any online market site depends upon its ability to provide an experience of security and an easy-to-use environment in which buyers and sellers can conduct business efficiently. Current online IPR market places fall short with regards to these requirements.

Current online Intellectual Property Right (IPR) market sites have certain limitations in what they show and how they present information to users. An IPR market site will be expected to show only those items that are offered by the operator of the IPR market place, or where the operator at least takes a cut if the item is ordered via the IPR platform. A viewer accessing the platform does not perceive the operator as impartial, and consequently does not trust any of the information other than what can easily be confirmed. More importantly, where the site states patent numbers, the visitor typically is unsure about his/her moves on the site being tracked and, due to the presumed interest link between site operator and eventual purchaser, worries that, one day, tracking information could be used against him or her, in particular in case the patent viewed on the platform should later be asserted against the visitor or an entity related to the visitor.

Further, due to the unique nature of intangibles, a patent, trademark or other intangible asset is unlike a commodity good whose price is typically widely known from previous transactions involving the same or a similar kind of product. As a consequence, establishing a price of an intangible asset is a difficult affair.

In the world of tangible goods auctioning seems to successfully address the price issue, for example, with vintage goods or collector's items. Users of the Internet increasingly use an Internet auction platform. More and more Internet users are realizing the ease and convenience of buying and selling online by way of person-to-person online trading. As a result, collectors, hobbyists, small dealers, unique item seekers, bargain hunters, and other consumers, are able to buy and sell millions of items at various online shopping sites. However, despite the obvious need for an extension of electronic market places from tangibles to intangibles, online market places for intellectual property rights, in particular for patents and trademarks, have failed to develop anywhere as much as for tangible goods.

### Description of Prior Art

Recently, auction platforms such as Ocean Tomo™ have further attempted to offer intangibles similar to goods being offered in online auctions. While on the one hand, the number of intangibles in each individual auction may be too large for a potential buyer to evaluate the worth and, thus, an appropriate bid price for the intangibles, the number of intangibles is too small for any potential buyer with a well-defined need for an intangible to have hope to find such intangible in any particular auction. Further, listing platforms such as ideabuyer.com, shop4patents.com, PatentAuction.com and idea4sale.com have been created as Internet sites. Such sites, upon selection of a particular technical field, offer internet pages that list know-how and/or patents for sale. The sites are to satisfy an apparent demand by owners of know-how and/or patents for space to announce the availability of their know-how and/or patent for sale. However, clearly conventional listing platforms do not appeal to potential buyers in search for patents and, as a consequence, are not suitable to establish a broad market in intellectual property rights. There is a patent need to facilitate development of a market for intellectual property rights.

United States Patent Application 2005/0261927A1 (Bilak, Dauser, Madden, and Srikrishnan) discloses a method, system, and machine-readable medium having instructions recorded thereon for valuing a current intellectual property (IP) transaction. The method includes providing IP data, financial data, and license data, the license data representing transactions other than the current IP transaction. A license value is obtained by referring to the license data. The value of the current IP transaction is determined by adjusting the license value in relation to the IP data, the financial data, and at least one of: i) trend data and ii) at least one quality factor.

### SUMMARY

The present invention is based on insight into the interest of potential buyers of intellectual property rights (IPR) such as patents. A typical interest of a potential patent buyer is to purchase a right to have a third party discontinue certain business, in particular, to have that third party cease performing a certain method or to stop selling a certain product. Consequently, the invention considers the need of such potential buyer to identify, in a large set of data related to intellectual property rights, such intellectual property rights that fit the potential buyer's specific requirements.

An implementation according to the present invention aims to fill a gap between potential sellers of IPR, in particular patents, know-how and trademarks, and potential buyers. For example, in one embodiment a potential buyer with access to the Internet can view IPR listed on an Internet platform as being available for sale or license, then turn to a point of contact provided for a particular patent of interest, and negotiate a deal. At least one effect of this implementation is to remove barriers between patent owners and potential buyers. Thus, the Internet platform in this embodiment dramatically enhances the likelihood of deals being done whereby establishment of an IPR market is facilitated.

Keeping costs low for patent owners can be important. In an embodiment, the Internet platform achieves low costs by charging patent owners only an administrative charge for entering the IPR in the platform's IPR list and for keeping it listed. In an embodiment, the Internet platform can earn profit by charging providers of IPR related services for advertising their services on the platform.

In the following, some embodiments of the present invention will be described in detail. It is to be understood that the following description is given only for the purpose of illustration and is not to be taken in a limiting sense. The scope of the invention is not intended to be limited by the embodiments described hereinafter with reference to the accompanying drawings, but is intended to be limited only by the appended claims and equivalents thereof.

It is also to be understood that in the following description of embodiments any direct connection or coupling between functional blocks, devices, components, circuit elements or other physical or functional units shown in the drawings or described herein could also be implemented by an indirect connection or coupling, i.e. a connection or coupling comprising one or more intervening elements. Furthermore, it should be appreciated that functional blocks or units shown in the drawings may be implemented as separate circuits in some embodiments, but may also be fully or partially implemented in a common circuit in other embodiments. In other words, the provision of functional blocks in the drawings is intended to give a clear understanding of the various functions performed, but is not to be construed as indicating that the corresponding functions are necessarily implemented in physically separate entities.

### BRIEF DESCRIPTION OF THE DRAWINGS

The Figures show views of an Internet platform according to an embodiment. Herein:

FIG. 1 is a view of an exemplary network.

FIG. 2 is an view of an exemplary client terminal screen display in an embodiment including an IPR list.

FIG. 3 is a view of another IPR list with a first combination of displayed data fields.

FIG. 4 is another view of the IPR list in FIG. 3 with a second combination of displayed data fields.

FIG. 5 is a view of highlighting a publication number field in the IPR list of FIG. 4.

FIG. 6 is a view of a publication window opened upon clicking in the publication number field highlighted in FIG. 5.

FIG. 7 is a first view highlighting a search/filter field to perform a first text filtering on the IPR list of FIG. 3.

FIG. 8 is a second view highlighting the search/filter field to perform a second text filtering on the IPR list of FIG. 3.

FIG. 9 is a view highlighting a contact field in the IPR list of FIG. 3.

FIG. 10 is a view highlighting an advertisement column next to the IPR list of FIG. 3.

FIG. 11 is a view of an advertisement window opened upon clicking in the advertisement column highlighted in FIG. 10.

FIG. 12 is a chart of a method according to an exemplary embodiment, the chart showing flow of information from one node to another, not necessarily directly, and processing and selection of information related to a unique item such as IPR.

Some of the above concepts as well as additional optional features and examples for environments where such embodiments may be implemented will now be described in the detailed description that references the accompanying figures. In the figures, the left-most digit(s) of a reference number identifies the figure in which the reference number first appears. The same numbers are used throughout the drawings to reference like features and components. Also, note that any text smaller than ten point is presented merely to indict where text would appear in the depicted figures. Since such text is merely an indicator of where text might appear, the content of such text is unimportant to the understanding the implementations depicted.

### DETAILED DESCRIPTION OF THE INVENTION

Described herein are implementations of embodiments. The described implementations are particularly useful to understand concepts underlying embodiments according to the present invention.

The present invention provides a method and system and software for use to establish a communication between a potential buyer of an intellectual property right (IPR) and a potential seller of such IPR. In other words, an implementation of the present invention can be used in an IPR market.

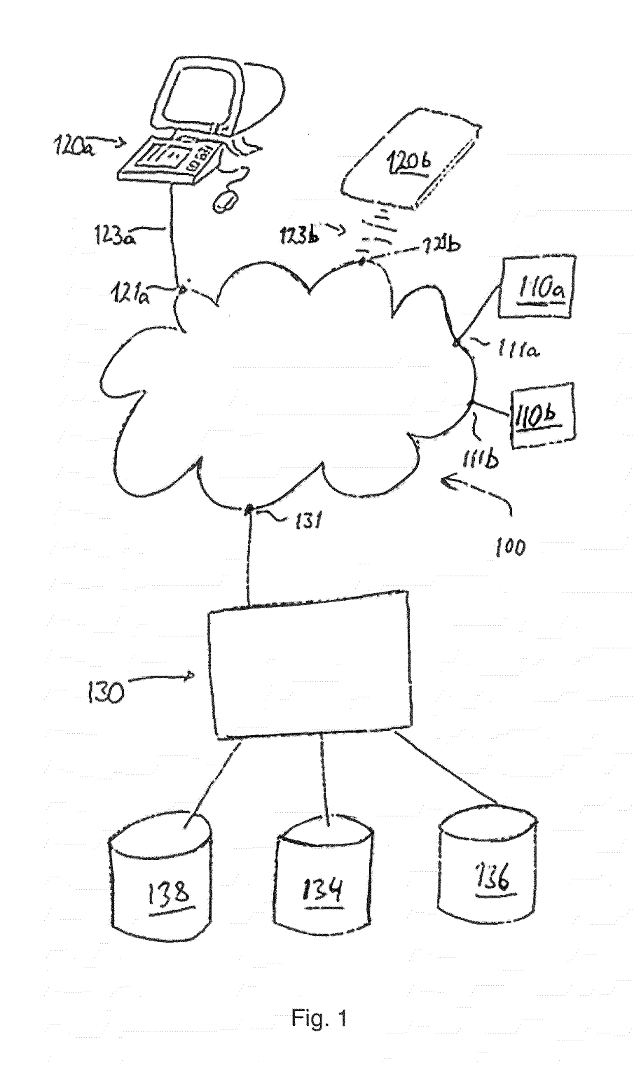

FIG. 1 shows an exemplary implementation in a network 100. The network 100 includes a first node 111, herein also called computer node and shown in FIG. 1 as computer nodes 111a, 111b, a second node 121, herein also called terminal node and shown in FIG. 1 as terminal nodes 121a, 121b, and a third node 131, herein also called server node 131. For example, the network can be the Internet. Each node can be associated with a respective address. The address can be an Internet Protocol address (IP address). The address suits to communicate with any device coupled to the node. In the implementation shown in FIG. 1, for example, an agent computer 110, shown in FIG. 1 as agent computers 110a, 110b, is coupled to computer node 111, a client terminal 120 is coupled to terminal node 121, and a database server 130 is coupled to server node 131. It will be appreciated that any number of agent computers 110a, 110b can be coupled to the network 100 via respective computer nodes 111a, 111b. Likewise, it will be appreciated that any number of client terminals 120a, 120b can be coupled to the network 100 via respective nodes 121a, 121b. It will be appreciated that coupling can be performed directly—as shown in FIG. 1—or indirectly via intermediary device such as a router server (not shown). It will be appreciated that coupling can be performed using any media such as wireline 123a or wireless 123b.

Without limitation, using the network 100, agent computer 110 can address server node 131 and can communicate, via computer node 111 and server node 131, with database server 130. In an implementation, database server 130 can address computer node 111 and can communicate, via server node 131 and computer node 111, with agent computer 110. Further using the network 100, database server 130 can address terminal node 121 and can communicate, via server node 131 and terminal node 121, with client terminal 120. In an implementation, client terminal 120 can address database node 131 and can communicate, via terminal node 121 and server node 131, with database server 130. Further, using the network 100, client terminal 120 can address computer node 111 and can communicate, via terminal node 121 and computer node 111, with agent computer 110. In an implementation, agent computer 110 can address terminal node 121 and can communicate, via computer node 111 and terminal node 121, with client terminal 120. Use of network 100 is an example. Afore-described correspondents, in some implementations, alternatively or additionally, may have other means and/routes at their disposal for communication amongst themselves.

Agent computer 110 stores information related to one or more intellectual property rights IPR that an agent seeks to sell. The wording “agent” encompasses any person or entity entitled and willing, or acting on such person's behalf or at such person's request, to enter into an agreement about a transaction related to the IPR, whereby the IPR is transferred to a third party or encumbered to the benefit of a third party against consideration. It will be appreciated that more than one agent can use the present implementation, and typically will be. Accordingly more than one agent computer 110a, 110b can be coupled to the network 100. Further, in an implementation an agent may not use a single agent computer 110 for its communication. Consequently, the term “agent computer” should be understood to encompass a plurality of devices as well as different devices at separate times. Also, the term “agent computer” should not be understood limiting to any specific kind of device such as Personal Computer or tablet computer or server etc. as long as the device can communicate directly or indirectly with computer node 111 and thus can use network 100 for communication.

Client terminal 120 has means for entering data and displaying data. This means is shown in the case of client terminal 120a as a mouse for data entry, and as a screen for data display. Other means are equally well known such as a touch screen of tablet computer 120b as in the case of client terminal 120b. In an implementation client terminal 120 is capable of using the network 100 and process software, for example, if provided in a script language such as Javascript.

Database server 130 is coupled to a first memory 134 holding IPR data, in particular identifiers. Database server 130 is coupled to a second memory 136 holding address data such as e-mail addresses. Database server 130 is coupled to a third memory 138 holding software, hereinafter also called terminal software, for execution on a terminal device. Database server 130 further has or is coupled to storage to hold software, hereinafter also called server software, for execution on the server itself. It will be appreciated that any combination of first, second and third memory 134, 136 and 138 and the further storage can be implemented in a single physical memory circuit or other storage medium such as magnetic, optical, punch card. Any memory circuit can be integrated with other circuitry included in database server 130 such as processor circuitry. The database of database server 130 can be modelled as a relational database, though other implementations known in the art could be used as well.

In an embodiment the database is provided as a relational database. In an embodiment a Structured Query Language (SQL) is used to enter to and/or retrieve data from the database. In an embodiment a MySQL database is used. In one alternate embodiment the database is provided as an Extensible Markup Language (XML) database. In an embodiment a hybrid form is provided wherein some data are organised in the relational database and other data are organised in the XML database.

IPR data and/or other data to be processed on the database server can be held in one or more databases, the database to comprise a plurality of data records. An exemplary data record of the database may merely include data to represent an identifier and a relation defined to point to a address information associated with the identifier. If nothing else were known, a combination of identifier and address information would be sufficient for a user to direct an indication of interest in the IPR identified by and/or associated with the identifier to its owner.

The identifier can be anything that specifically points to an intellectual property right (IPR). For example, the identifier can be database portfolio identification number that identifies a portfolio including one or more IPR bundled to provide a single offer. Such identifier may reference a list that defines IPR belonging to the respective portfolio on offer. A patent portfolio thus identified may, for example, consist of all family members of a patent, i.e., all IPR that go back to a same first application or to a plurality of same first applications such as the first application(s) and subsequent application(s) that claim priority of the first application(s). To take another example, certain documentations, drawings, patent applications, patents and contracts can belong to a certain know-how to be collectively identified by the identifier. To take yet another example, all registrations, registration applications and use rights of a same sign as a trademark can form a family to be identified by a single identifier. In yet another example, all registrations, registration applications and use rights of wordmarks, related logo(s) and other related signs can form a trademark portfolio to be identified by a single identifier. In an embodiment the identifier comprises at least one selected from a group consisting of: an application number, (ii) an application date, (iii) a country and/or office of application, (iv) an registration number, (v) a registration date, (vi) a country and/or office of registration, (vii) a publication number, and (viii) a database specific identification.

IPR information associated with the identifier can be any information about the IPR identified by the identifier that enables grouping of IPR. IPR information can, for example, include category information, flag information and/or class information.

Category information associated with an identifier is indicative of a category to which the IPR identified by the identifier pertains. In an embodiment, category information indicates at least one of a group consisting of: (i) availability for purchase, (ii) availability for license, (iii) belonging to a certain family of IPR, (iv) belonging to a certain owner or group of owners, (v) belonging to a certain IPR portfolio, (vi) belonging to a certain technical field, (vii) belonging to a certain International Patent Class (IPC), and (viii) belonging to a certain Nice class. It should be understood that category information can indicate that the IPR identified by the identifier that is associated with the category information belongs to a plurality of categories.

Flag information (herein also simply denoted as “flag”) associated with an identifier is indicative of a feature in IPR identified by the identifier being present or absent. For example, in an embodiment the database includes flag information to indicate at least one of a group consisting of availability of the IPR for either purchase or license. Presence of a feature in the IPR can define the IPR to belong to certain category such as, in the example where the associated flag is set to “sale”, the identified IPR has the feature of being available for sale and thus the category of IPR for sale pertains to the identified IPR.

In an embodiment, the database includes class information associated with the identifier. In an example of patents as IPR, IPR information can include technical class information. The class information may be descriptive information such as a keyword, standardised information such as a class defined in the so-called International Patent Classification (IPC), or proprietary information such as a class defined specifically for use with the database. In an example of trademarks as IPR, IPR information can include class information stating goods and/or services, or stating a standardised class such as defined in the so-called Nice Classification. Class information may comprise at least one classifier. The classifier may be, for example, a class in the IPC or a class in the Nice Classification.

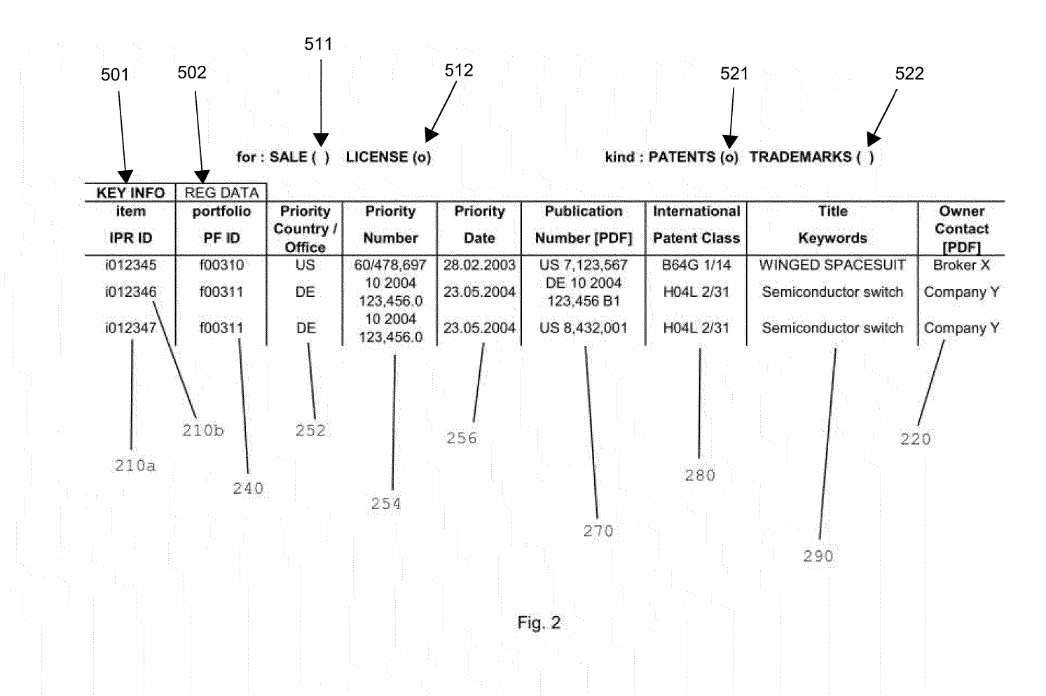

FIG. 2 shows exemplary information represented by data provided in the database of database server 130. The data encompass identifiers 210 and contact information 220. Contact information encompasses any information or portion of information that enables a user to address a message, and is herein also referred to as address information. Address information associated with the identifier can be anything that points to the owner of the IPR identified by the identifier associated with the address information. For example, address information could be an Internet link address of an Internet homepage of the owner of the IPR. Address information could be path and/or file information of a text or other file such as a PDF file available for download and/or viewing by the user that includes any other address information for the user to view such as a postal address of the owner of the IPR identified by the identifier associated with the address information. In one implementation, an icon can be contact information. The icon can be provided with a link to an Internet page or a other document stating address information such as an address and/or an e-mail address. In an embodiment the address information includes at least one of a group consisting of: (i) a postal address, (ii) a telephone number, (iii) a facsimile number, (iv) an e-mail address, (v) an Internet address, (vi) a name of company, (vii) a name of a department, and (viii) a name of natural person.

Typical other information represents at least one attribute of the IPR identified by the associated identifier and is herein also referred to as attribute information. For example, attribute information can include at least one in a group consisting of: (a) flag information, (b) category information, (c) class information, (d) owner information, (e) price information, and (f) encumbrance information. Flag information can be to indicate at least one of a group including but not limited to (i) availability for purchase, (ii) availability for license. Category information can include at least one of a group including but not limited to (i) technical field of invention, (ii) use field of invention, (iii) associated portfolio. Class information can include at least one of a group including but not limited to (i) International Patent Class, (ii) owner-defined patent class, (iii) Nice class. Owner information can include at least one of a group including but not limited to (i) material owner, (ii) registered owner.

Data in the database that represent the information may be organised in data records. It should be noted that in this specification, for the sake of brevity, the wording “data representing X” and “X” may be used synonymously. In an embodiment the database may be to comprise a plurality of data records, the data records to have at least two data fields, a first field to hold the identifier and a second field to hold the first address associated with the identifier.

An exemplary record comprises data to represent all information associated with a single identifier such as identifier 210a. The record may be organised in data fields, wherein a field can be dedicated to hold data that represent information such as contact information 220, portfolio information 240, earliest filing information 252, 254, 256, publication information 270, publication number 272, link 274, class information 280 and/or other information such as technical or commercial information 290. It will be appreciated that a field could also be defined to hold further data representative of information associated with the respective identifier. It will be appreciated that such association may be indirect, i.e., by a relation to a further field other than the field holding data that represent identifier 210, wherein the further field is related to the field holding data that represent identifier 210. It will be appreciated that some fields do not hold any data, while other fields may hold data in some records while not holding data in other records. The skilled person will understand that at any time of operation of the database data may be added to fields, data may be deleted from fields, data may be updated in fields, as the case may be. In particular, the database may not have all fields of a record filled with data. For example, for lack of availability, a record having an identifier to represent a patent application not yet published, may lack any data representative of publication number. However, data representative of an application number associated with the identifier may be present in a field dedicated to hold such information.

The server software may comprise instructions that when executed cause the server to enter data into the database as presented to the server. Data can, for example, be provided in a data file such as a text file format, a spreadsheed file format, a database file format, an XML file format or other format for data files that the server software is adapted to for reading. The data file may be provided to the server via e-mail, memory stick coupled to the server, upload from a computer at the first node, or other channel, link or communication suitable for providing data to the server. The server software may comprise instructions that when executed cause the server to enter data representing identifier information into the database wherein the identifier information is associated with a data record stored in the database. The server software may generate such identifier, for example, when creating the data record associated with the identifier. A predetermined identifier may also be used.

The server software may further have instructions that when executed cause the server to read IPR information from the data file so as to populate data fields of the data record with IPR information corresponding in type to a type of the data field. For example, the server software may read address information from the data file and populate a record of an address data base with the address information. Further the database may store a relation between the record having the IPR information and the record having the address information so as to reflect an association between the IPR information and the address.

In an embodiment the server software (hereinafter also called Website software) comprises client software. In an embodiment the Website software to run the Website is implemented on a LINUX™ server environment. In an embodiment at least a portion of the software is provided in a script using a script language such as the Personal Home Page (PHP) language. In an embodiment running the Website encompasses operation of the database.

An embodiment of the Website external to the operation of the database uses a Content Management System (CMS). In one embodiment such CMS system is provided under the name of “Textpattern”. The CMS uses the database to retrieve store data and to retrieve data. In an embodiment data in the database need not be limited to IPR-related data. The database can also store software code to be executed on the server. In an embodiment the database can store software code to be executed on a client computer, for example, in building the list at the client computer. At least one effect of using the CMS is that an administrator of the Website can easily modify Website content.

In an embodiment software for providing data that represent IPR information is written in PHP language. At least one effect of using PHP may be that the software can be used independently from any use of the CMS. Data can be provided in a text file. The software written in the PHP language may be able to read the data from the text file and enter the data into the database. In the database the data can be organised in data records.

In an embodiment the software may be able to process data queries that result in a selection of data being retrieved from the database and provided for further processing. In an embodiment the further processing includes building a list to show, in each retrieved data record, at least a portion of all data fields in a record.

In an embodiment the client or terminal software may be able to process data queries that as a result provide a selection of data in the data base. The data retrieved from the database may be processed using the server computer and/or provided to the client computer for building a list to show at least a portion of data fields in each retrieved record. In an embodiment the client computer can further limit the amount of data shown by performing a second query within the data records provided from the server. At least one effect is that a only a portion of all IPR-related information residing in the database needs to be transmitted from the server to the client, wherein that portion can be defined so as to reflect a user's interest. Using only the limited data the user may then proceed to search within for that IPR-related information that pointedly reflects the user's interest. Thus an appropriate balance between data security needs in respect of the data stored in the database, bandwidth and time available for transmission of data from the server to the user, client computer processing power, and storage available for session storing data may be found.

In an embodiment data are provided from the IPR information provider to the server using a File Transfer Protocol (FTP). Other means for providing data may also be contemplated such as using e-mail, facsimile transmission, conventional paper letter or list and other means for providing information. Depending on the means the data may be entered into the database manually, using Optical Code Recognition (OCR) software or data file import functionality of the database or the like. In an embodiment entry of data into the database is performed by instructions included in a PHP script. In an embodiment a query script is to run on the client computer. The query script may provide filter functionality and/or sort functionality. In an embodiment the query script is based on an Asynchronous JavaScript and XML (AJAX) framework such as JQuery™.

In an embodiment a list of IPR information retrieved from the data base may not be shown to a user unless that user established a session with the Website. Establishment of a session with the Website may encompass entry of a password. In an embodiment the password is selected so as indicate user agreement to predetermined terms and conditions of use of the Website. The agreement may effect a contract defining the terms and conditions of use the Website, such as a contract with the platform operator, wherein the contract is binding upon the user. Acceptance indication may be provided by clicking a button shown to the user or by entering the password into a password filed shown to the user. In an embodiment a so-called session cookie may be generated. For example the session cookie may be to track all movement of the user during the session and store each and every movement for later. Storage may be limited to the client computer. In another embodiment at least a portion of tracked data may be communicated to the server computer. In an embodiment storage may be limited to the session. In another embodiment storage of at least a portion of the tracked data may be stored on the client computer for use in a later session.

FIG. 2 also shows an exemplary implementation to view the information and/or data at a terminal screen. A window may have a first tab 501 and a second tab 502. The first tab 501 may to display listed information of primary interest to a user. The second tab 502 may be to display listed information of secondary interest to a user after having inspected the information presented in the first tab 501. In the exemplary implementation shown in FIG. 2, pre-selector radio buttons 511 and 512 enable the user to pre-select items for listing that conform with the user's interest in, for example, either items for sale or for licensing. Similarly, radio buttons 521 and 522 enable the user to pre-select IPR for listing that conform with the user's interest in, for a further example, either patent or trademark. FIG. 2 shows a portion of data of one record arranged in lines and data of one type of data field across records arranged in columns. Other arrangements of information may be possible and are within the scope of this invention.

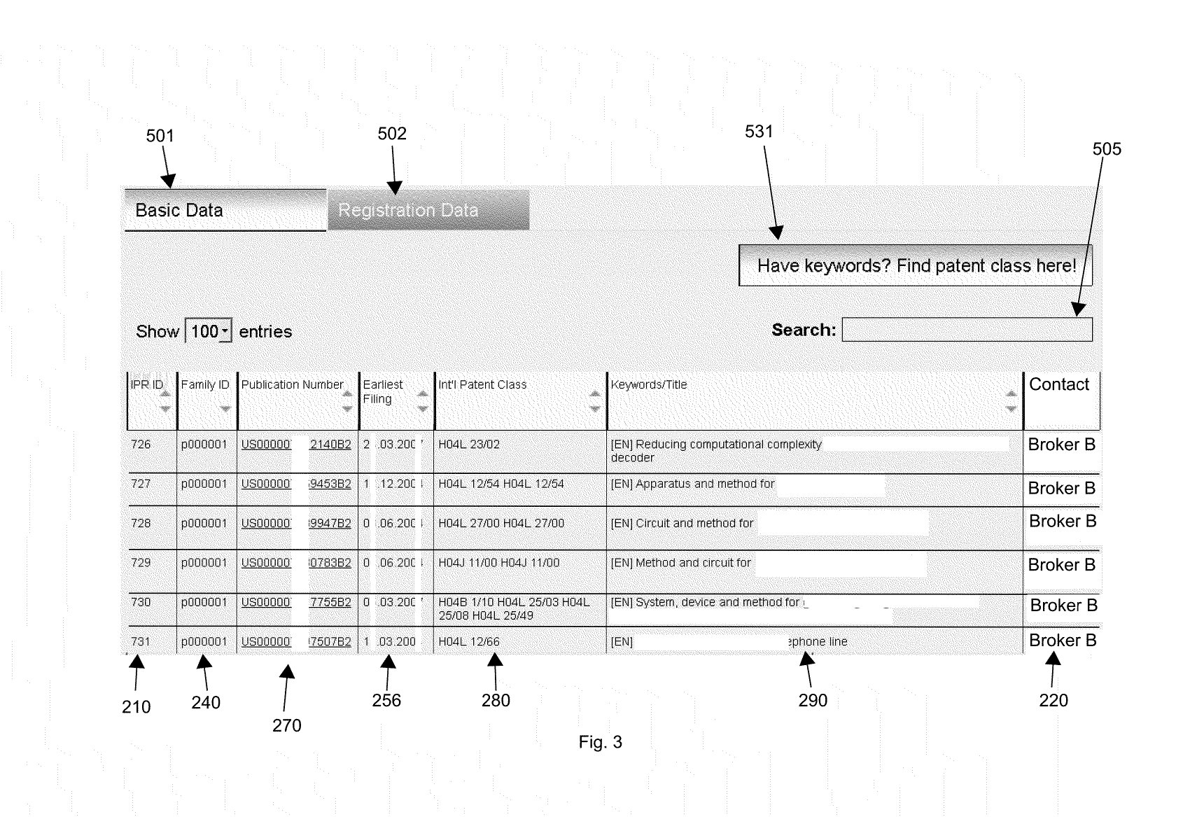

Turning now to FIG. 3, a sectional view on another IPR list with a first combination of data displayed in the first tab 501 is shown. The view in FIG. 3 includes a search field 505 and a button 531. Button 531 is coupled to an embedded link for accessing services provided at another node coupled to network 100 and of interest to a user wishing to filter listed data with respect to patent class information 280.

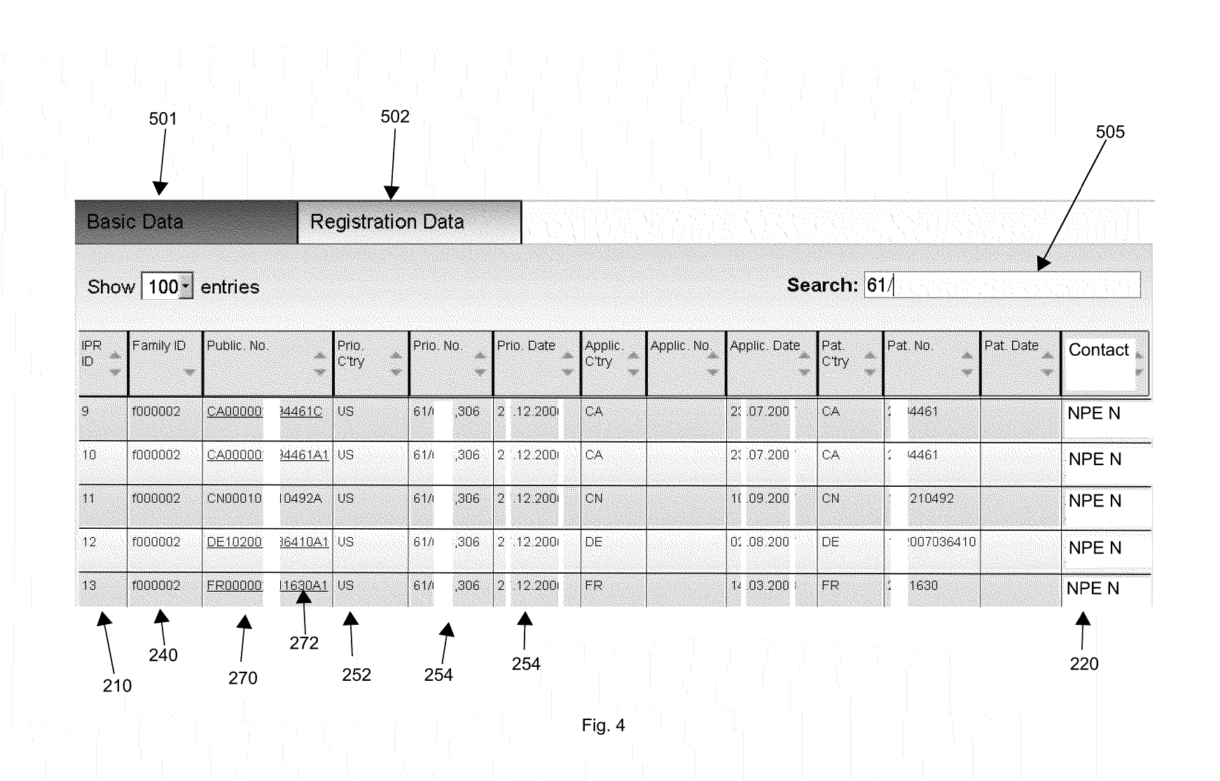

FIG. 4 shows the sectional view of FIG. 3, however, with a second combination of IPR data displayed in the second tab 502. It will be noted that the second tab 502 does not feature button 531 as the data shown in the second tab 502 do not include patent class information 280. In FIG. 4 the search field 505 is shown to be used to filter data records including the character sequence “61/” for display in the list of the second tab 502.

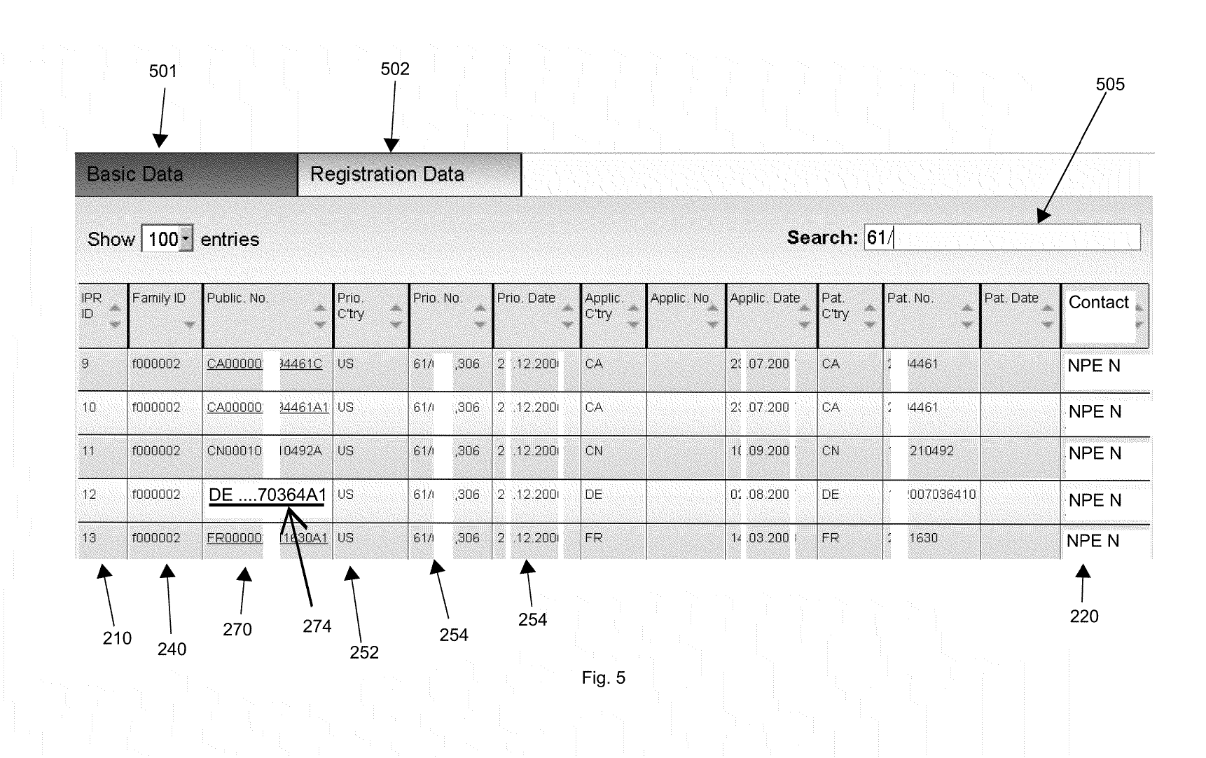

Each contact information 220 shown in FIGS. 2, 3, 4 and 5 is associated with one or more identifier 210a, 210b. In the example, each identifier 210a, 210b is associated with a same contact information 220 (“Company Y”). In an alternate implementation, an association of an identifier with a plurality of contact information may be contemplated. Other information may also be associated with the identifier 210. In the examples shown in FIG. 2, FIG. 3, FIG. 4, and FIG. 5, other information encompasses portfolio information 240, earliest filing information 252, 254, 256, publication information 270 such as a publication number 272, class information 280 and technical information 290.

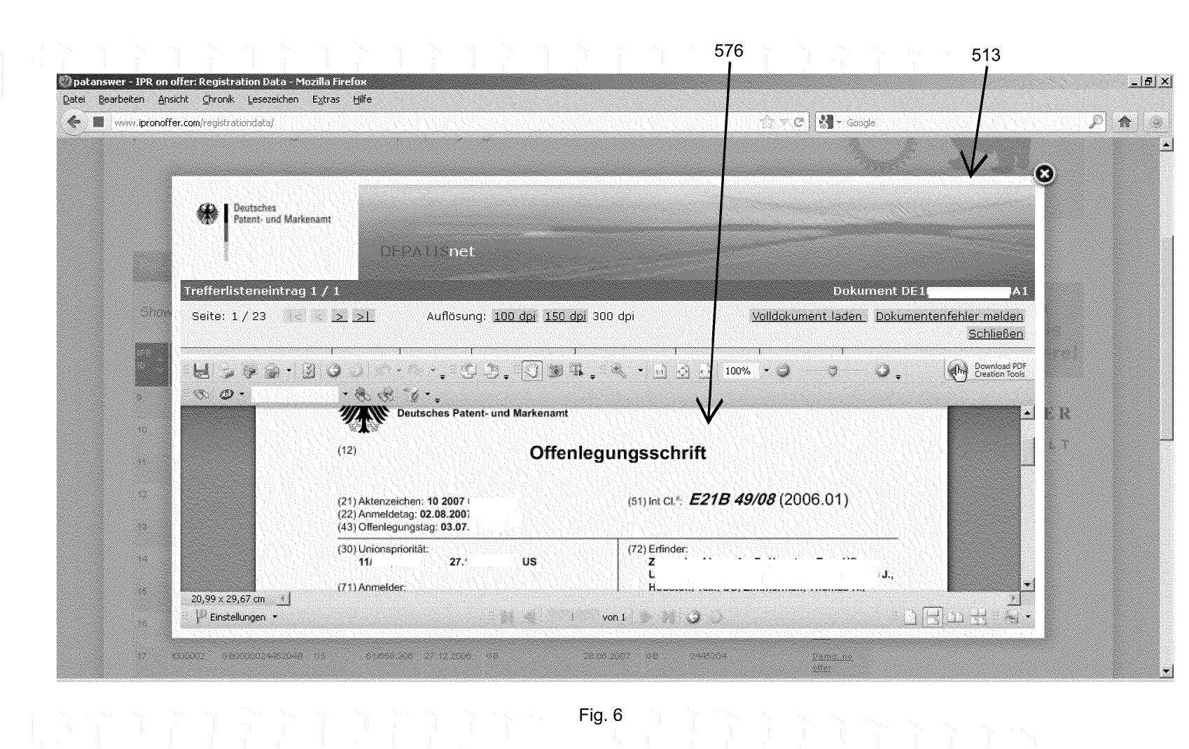

FIG. 5 shows an implementation where publication information includes a link 274 to a file, for example, in Portable Document Format (PDF), that includes more detailed information such as an excerpt from an official register where an associated IPR is registered and/or the publication itself. FIG. 5 shows highlighting publication number field 274 for the user to access information provided in the PDF file. FIG. 6 shows a pop-up window 513 to open upon clicking the publication number field 274 highlighted in FIG. 5 for the user to view publication 276 comprised in the PDF file.

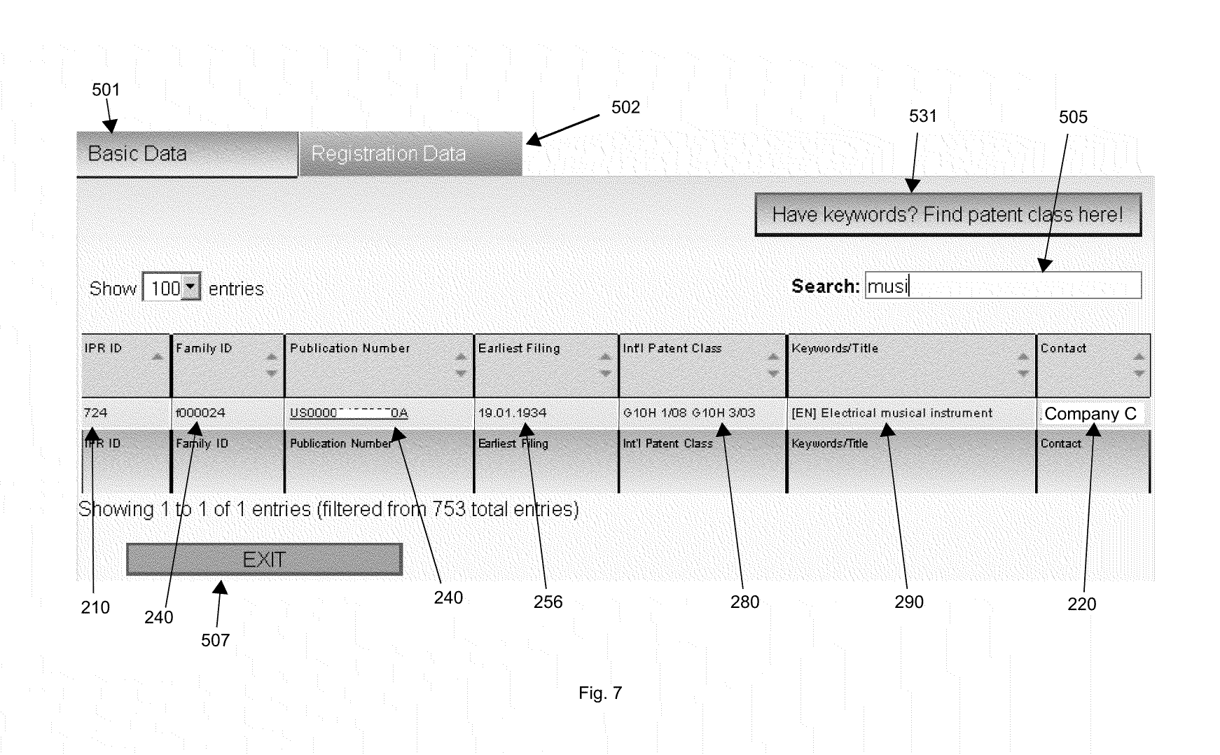

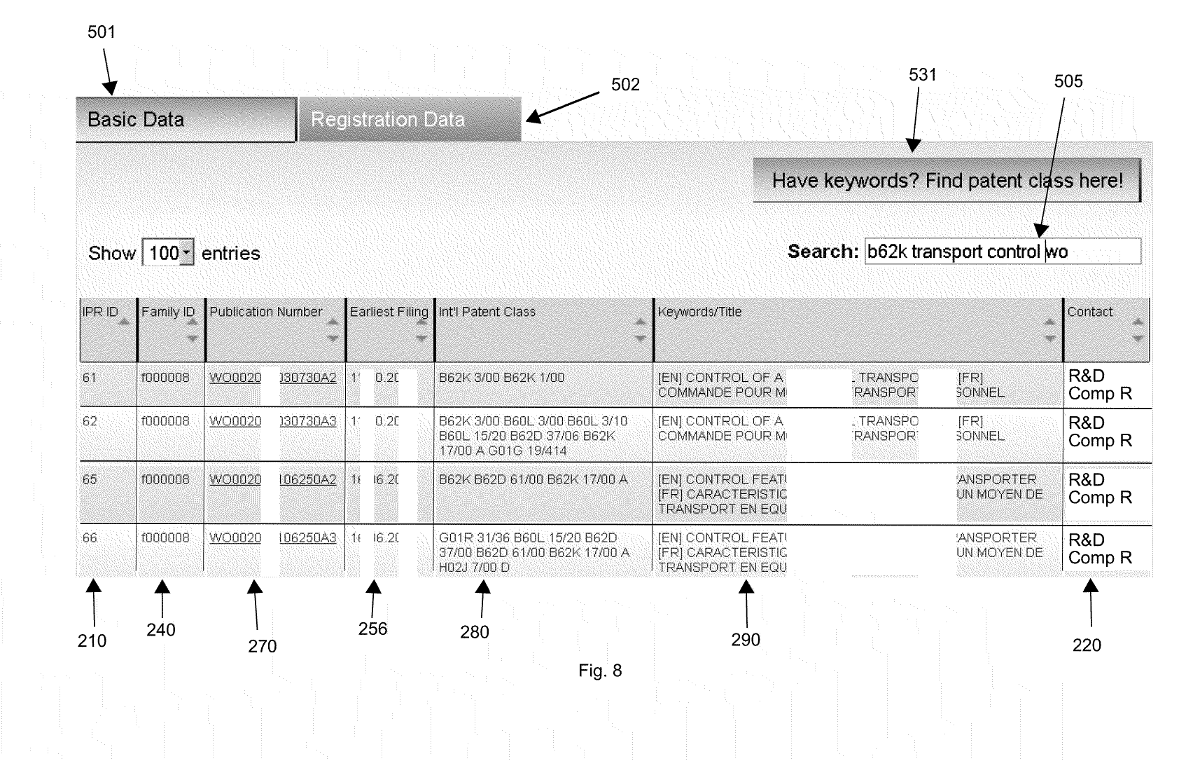

FIG. 7 shows another example of the first tab 501 wherein the search/filter field 505 is used to perform a first text filtering on the IPR list of FIG. 3. A single item in the data listed in the terminal's list is shown to fulfil the filter criterion entered into the search/filter field 505. FIG. 8 shows yet another example of the first tab 510 where the search/filter field 505 is used to perform a second text filtering on the IPR list of FIG. 3. Several records in the data included in the terminal's list are shown to conform to the filter criterion entered into the search/filter field 505.

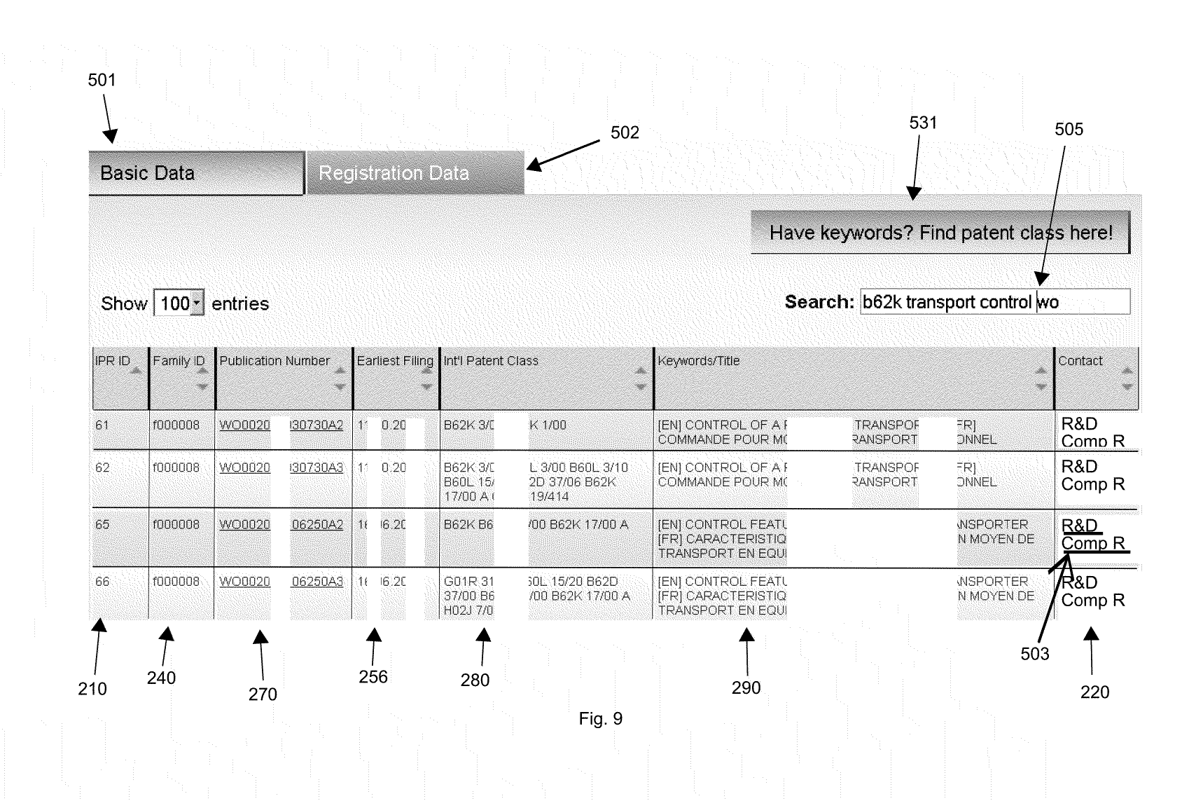

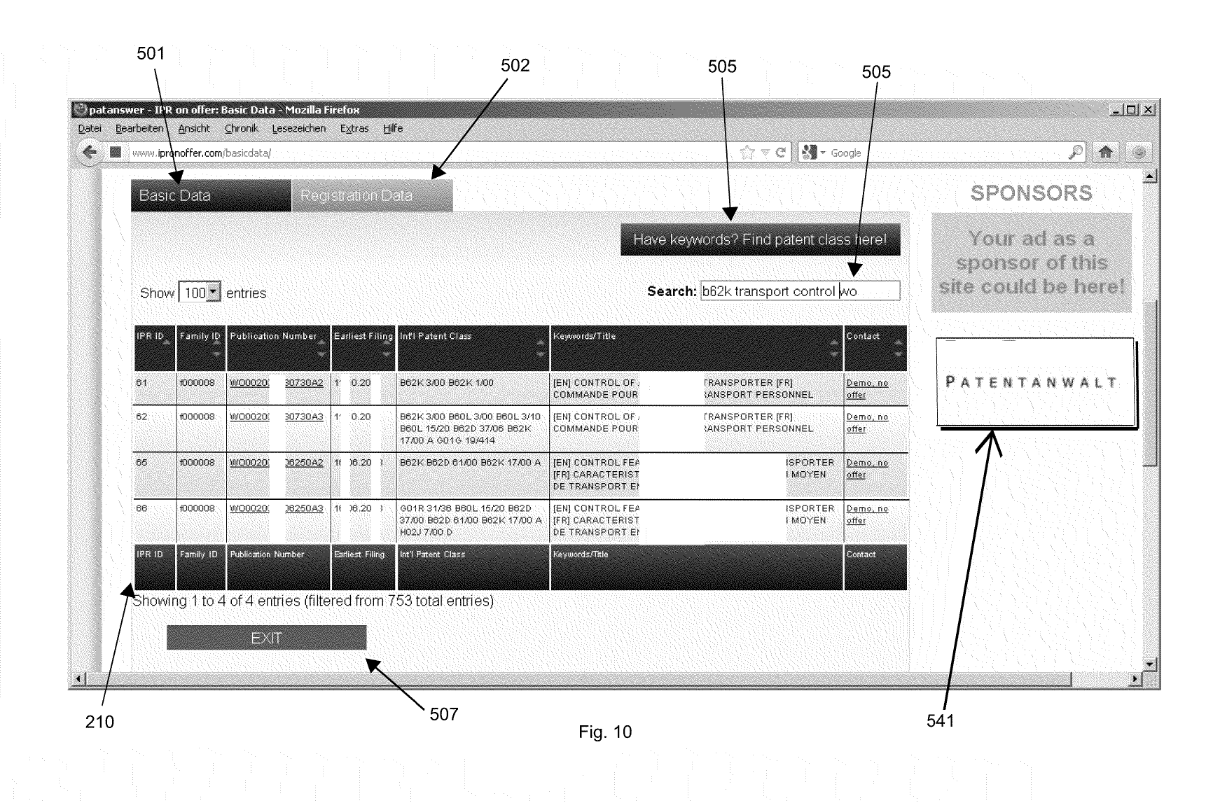

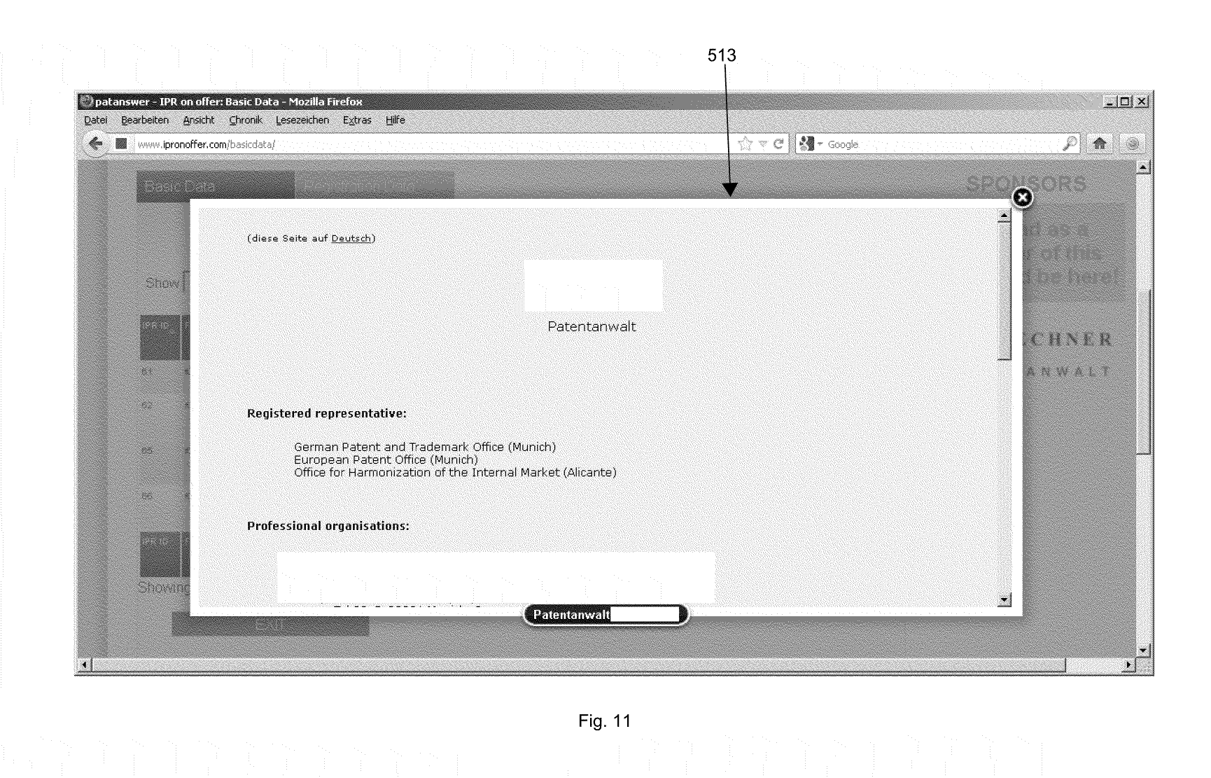

FIG. 9 shows “clicking” a contact field in the IPR list of FIG. 3 and will be described in more detail with reference to operating the terminal 120. FIG. 10 shows “clicking” a sponsor advertisement column next to the IPR list of FIG. 3 and will also be described in more detail with reference to operating the terminal 120. FIG. 11 shows an advertisement window opening upon clicking in the advertisement column highlighted in FIG. 10.

Below, an embodiment implemented, for example, in the above-described network 100 having the computer node 111, the terminal node 121 and the server node 131 and with portions of hardware and/or software such as agent computer 110, client terminal 120 and database server 130 as described above will be further described.

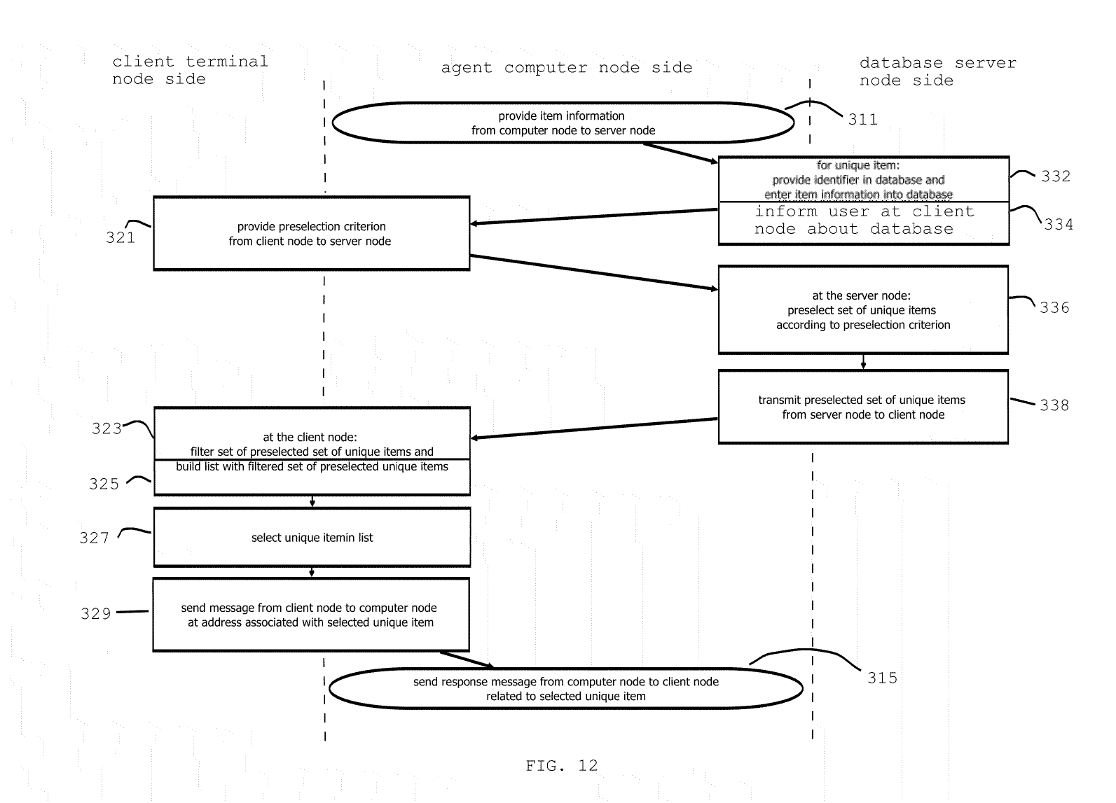

An IPR owner may have decided to offer certain IPR for sale. If the IPR is, for example a set of patent families, wherein each family has one or more patents or patent applications that commonly claim priority to at least one priority application, the IPR owner (hereinafter also called patentee or agent) collects data from registers of patent offices where the patents and/or patent applications are registered. The patentee may add data to the file that patentee considers relevant to attract third party interest in the patents. The patentee or agent may process the collected data and the added data, for example, by writing the data into a Comma-Separated Values (CSV) formatted data file, for transmission, for example using a file transfer protocol (FTP), to a service provider that operates a database. For example, in FIG. 12, at 311, the agent transmits the data from agent computer 110 at the computer node 111 to the database server 130 at server node 131.

The database server runs server software data to extract data from the received data file and import the data into the database which is stored in first memory 134 as shown, for example, in FIG. 12 at 332. The database operator (herein also called service provider, though in practice service provider and database operator may be different entities that, seen from outside the third node, may be hard to distinguish) may organise the imported data in data records comprised in the database. As a unique item, each patent may be represented by a data record that is assigned to an identifier to enable identification the patent. The database operator maintains an association between the identifier and contact data of the agent or any other person designated by the agent to receive enquiries related to the patent associated with the identifier. In an embodiment the data record includes at least the identifier and address link data that relate the identifier with a contact data table that in one embodiment is stored separate from the database in an address database in second memory 136, or that forms part of the database with IPR data stored in the first memory 134. The contact data table may comprise a plurality of contact data, in particular, the data table comprises contact data of the agent or the person designated by the agent. The person need not be natural, it can also be a corporate body or other legal person.

In addition to software related to receiving and transmitting data, and software to run the database on database server 130, the database provider or service provider stores in third memory 138 or otherwise has control of website software for accessing database 130 by the Internet and/or client terminal software for download to client terminal 120.

Exemplary use of database server website software and client terminal software will now be described.

A third party (hereinafter also called user) at terminal node 121 (herein also called client node or client terminal node) develops an interest in acquiring patents. The user may, for example, search for a patent used by a competitor company that the user would like to stop doing business with a certain product in the user's market. The user therefore seeks a patent that the competitor's product infringes. To this end, the user identifies technical features in competitor's product and is now desirous to inspect patents for sale, i.e., available for purchase by the user. Thus, the user hopes to find a patent whose protective scope encompasses one of the identified technical features present in competitor's product. At 334 in FIG. 12, information about the existence of the database and related services in particular as described herein emanates from the server side to the user, for example, by an article in a newspaper, by direct mail, by word of mouth or by an advertisement.

Using client terminal 120 that runs, for example, a conventional browser software for access to the Internet, the user may establish a link between terminal node 121 and server node 131 and thus access database server 130. Database server 130 may transmit homepage information to client terminal 120 and thus present to the user a homepage that displays an agreement text comprising terms and conditions of use of the database server website. In an embodiment, the user accepts the terms and conditions, for example, by writing “I accept” into a designated text field. In an embodiment, content written into the text field may form a password assigned to a guest account for arbitrary “visitors” of the website. At least one effect of this implementation is that the user as an arbitrary visitor may stay anonymous. Likewise, the user could be “returning” after having established a password-protected user account with the website on an earlier occasion. In this instance, the user would identify itself and enter the password before be able to use the website.

The server software may have database server 130 transmit client terminal software from server node 131 to terminal node 121 where client terminal 120 executes instructions of the client terminal software to download data from database server 130, process the data and display the data on a monitor coupled to the client terminal 120 for inspection by the user.

In an embodiment, the client may now be shown a list of patents for sale in a list (FIG. 3). The client terminal software may be to show in a table, line by line, data extracted from all data records transmitted from the database server 130 to the client terminal 120. In order to accommodate limited screen surface, the client terminal software may “build” more than one list, each list comprising data associated with the same patents, the difference between the lists being that data were not taken all from the same data record fields.

In the example shown in FIG. 3, a first list called “Basic data” includes data of data record fields labelled “Priority Country”, “Priority Number”, “Priority Date”, “Publication Number”, “Int'l Patent Class”, “Title” and “Contact”. For example, a second list called “Registration data”, as shown in FIG. 4, may include data of data record fields labelled “Priority Country”, “Priority Number”, “Priority Date”, “Publication Number”, “Application Country”, “Application Number”, “Application Date”, “Patent Country”, “Patent Number”, “Patent Date” and “Contact”. The user may be able to select which list should be displayed at any moment, for example, by pointing and “clicking” the mouse.

Not all data provided from the database to the client terminal 120 need to be shown in the displayed list. For example, data that represent an Internet link or data generated by at the client terminal that represent a file system path may be included in the list but hidden from view. The user can, for example, use such data by “clicking” text such as “Publication Number” (FIG. 5) or an icon (not shown) in order to activate the link. Upon activation, an additional window, such as a popup window, may open to display further information retrieved from the linked Internet site or by following the file system path (FIG. 6).

Not all records provided from the database to the client terminal 120 need to be shown in the displayed list. For example, the client terminal software may display a search field. The user may enter text into the search field. At step 323, the client terminal software selects the data records whose data are shown on the screen or output to another output device according to the presence of the text entered into the search field in at least one data record field. In one embodiment, building the list takes user text into account. In one embodiment, shown for example in FIG. 12 at 325, building the list includes information associated with all identifiers, while the filtering limits which information in the built list is displayed or otherwise output to the user. Thus the user can “filter” the list of patents such that only those patents are shown that match certain criteria defined by the user. FIG. 7 shows an example where “musi” was entered into the search field 505. The client terminal software accordingly restricts the list of patents displayed to the user to those patents whose data record includes the string “musi”. FIG. 8 shows an example, where the user typed into search field 505 an International patent class plus additional text and thus limits the list of displayed patent records to patents that are associated with the respective International patent class and further comprise the particular text string.

The embodiments shown have in common that displayed list of patents includes column labelled “Contact”, and each patent shown in the respective list has an entry in the corresponding field 220. The user can view and/or, as exemplarily shown in FIG. 9 at 503, “click” the data in that field. A link or path—as described above with reference to FIG. 5—may display further data. In an important embodiment that data represents address information that enables the user to contact the agent of the associated patent's owner.

In the previously described embodiments, the user may have downloaded data of all patents provided in the database. If the database is large, the data transmission channel capacity between the server node 131 and the terminal node 121 is small and/or the data processing capabilities of the client terminal are small, the user may find download of all data inconvenient. The user may find the download also unnecessary since many patents may, from the user's point of view, quite obviously not meet the criteria that the user has in mind. Further, the service provider may not want to provide a set of data related to all patents to any unknown third party. Therefore, in an embodiment, prior to download of patent data from database server 130 to client terminal 120, the user may pre-select a set of patents whose data should be downloaded; see for example FIG. 12 at 336. Such pre-selection may be pre-configured, for example, by offering the user a number of radio buttons labelled with different fields of technology so as to select patent data for download of only those patents that are associated with the selected field of technology; see for example FIG. 12 at 338. In one embodiment, as described above, the user may enter text or other filter criteria into a search field, however, prior to download of data from the database. The text is transmitted from the client terminal to the database server. The server software is to perform a database query using the text received from the client terminal and to transmit to the client terminal merely the set of data resultant from the query. The user may then continue to view the data as described above. An effect can be that the amount of data transferred can be kept small, and accordingly the amount of data that need processing at the client terminal is small. The user thus can experience responsiveness even though computing and processing power of the client terminal may not be very large.

In an embodiment a session can be ended by closing a window of an active session. In the embodiment shown in FIG. 10 a session can be ended by hitting button 507 marked “EXIT” or the like.

Having selected or identified an IPR of interest, herein also referred to as fine-selected unique item or fine-selected IPR, for example in a selection of patents in the database that meet the user's criteria (see for example in FIG. 12 at 327), the user can now go ahead and contact the agent at the address associated with each selected patent. As shown, for example, in FIG. 12 at 329, using client terminal 120 at the terminal node 121 the user sends an e-mail to the agent's address. The e-mail may indicate, for example, an interest in the selected patent(s) the agent's address was associated with. In one embodiment the e-mail will merely indicate an interest to discuss matter. Using agent computer 110 at computer node 111 the agent can receive the e-mail, read its content and take action, for example by way of response as indicated in FIG. 12 at 315, so that a negotiation and perhaps a deal can ensue that results in a transaction and change of patent ownership.

Similarly, a licensing discussion can be started and a license agreement can result. The client terminal software may, in one embodiment, be provided so as to enable a pre-selection of either data related to IPR for sale or data related to IPR for licensing for download from the database server to the client terminal (see, for example, FIG. 2, where such selection is indicated).

In one embodiment, the database server is coupled to storage that stores advertisement data. The website software may include instructions that when executed on the database server cause the database server to transmit the advertisement data to the client terminal. The client terminal software may include instructions that when executed on the client terminal cause the client terminal to display advertisement. In one embodiment the advertisement is exclusively of service providers who provide service related to IPR. Advertisement data may be organised in records, each record including picture data, for example data in JPEG data file format that represent a firm's logo, and associated Internet link data that represent an Internet address of that firm. In an embodiment each record further includes unique rank data. The client terminal software may be configured to display picture data of each or of selected advertisements based on rank information represented by the rank data. FIG. 10 shows an example where the client terminal software displays a column 509 “SPONSORS” dedicated to advertisement. As explained with reference to FIG. 5, the user may “click” on a picture 541 in order to activate a link or path. FIG. 11 shows an example, where, upon link activation, a pop-up window 513 opens to show information that may attract the user to advertised services.

Within this specification and the appended claims ‘buyer’, unless stated otherwise, means any person interested in the IPR, potential buyer, prospective buyer, actual buyer and/or buyer's agent, i.e., a third person acting on behalf of the buyer such as an employee or a broker, irrespective of any contractual or other relation between the buyer and the third person who acts on behalf of the buyer.

Within this specification and the appended claims ‘seller’, unless stated otherwise, means any person offering the IPR, for example, the owner, owner's employee or agent, broker, prospective broker, future owner, any other third person acting as owner, on behalf of the owner, or as if this person were owner, irrespective of any contractual or other relation between the seller and the third person.

Within this specification and the appended claims ‘operator’, ‘platform operator’, ‘website operator’, ‘database operator’ or ‘server operator’, unless stated otherwise, means a person who is responsible for holding IPR data related to identifier and associated address and offering access to the IPR data to the buyer. It is to be understood that the database operator may use third parties for database management, server management, Internet accessibility and other technical functions.

Within this specification and the appended claims ‘at a node’ is not limited to mean any entity to be literally at a location of the node. The node can also be understood conceptually as a ‘point of contact’, a ‘side’, a ‘communication gate’, ‘interface’, or ‘communication device’ suitable for communication between the respective entity inside a sphere under that entity's control, including the node, and another entity outside that sphere. For example, ‘node’ can encompass an e-mail account in the cloud, i.e., on a server remote from and even unknown to the holder of the e-mail account, wherein the e-mail account falls within the sphere of control of the e-mail account holder, while the server where the e-mail is stored does not.

From one communication to the next, the node of one entity can encompass a variety of means as illustrated in the following example: a potential buyer at the second node may, in fact, have an employee use a first Internet access and a certain terminal device to retrieve IPR information data from the database, the entity may use another device at a different location for building and/or viewing the IPR list, and have yet another person such as an agent, use a separate e-mail account or other communication means at a different address for sending a communication request message to the seller. Still persons involved and/or means used in the process would be within the entity's sphere of at least indirect control and herein be denoted as the same node.

Below, further exemplary elements, implementations and embodiments according to the invention in various aspects are disclosed.

In one aspect an embodiment described herein provides a method of establishing communication in a network between a seller of an Intellectual Property Right (IPR) using a first node at a first address, and a buyer of the IPR using a second node at a second address. The method comprises, in a memory coupled to a third node at a third address, providing a database. The database may comprise a set of identifiers, each identifier to identify associated IPR and the first address associated with the identifier. The method further includes pre-selecting identifiers and transmitting the pre-selected identifiers and the first address from the third node to the second node. The method may include filtering the pre-selected identifiers for listing of filtered IPR associated with the respective pre-selected identifier. The method may further include transmitting a message including said second address from the second node to the first node, the message to indicate interest in IPR associated with the selected identifier. The method may comprise receiving the message at the first node. In response to the interest, a communication between the first node and the second node may be opened. At least one effect of the afore-described embodiment is that the database, even though it contains many data, can still be handled efficiently and viewed conveniently by a remote user who is interested in a subset of data. In an embodiment, the method seeks to strike a balance between (a) surely providing all data of interest from a database server at the third node to a client terminal at the second node, whereby processing all data in the client terminal may cause undue delay from a user's point of view, and (b) providing a small selection of data, thereby probably missing data of interest, from the database server to the client terminal, whereby processing the data will be accomplished swiftly. A conventional drawback of the user searching the database, wherein communication between the user's client terminal at the remote second node and the database server at the third node provides a slow bottleneck, can thus be avoided. Also, a conventional drawback of having to “freeze” database content in webpages for download by the user can be avoided. Avoidance of the afore-mentioned drawbacks can make use of the method attractive and help establish an IPR market.

At least one effect of the afore-described embodiment is that the communication between the first node and the second node is dissociated from the database coupled to the third node. This keeps a third node operator from using information related to a viewer using the site and/or related to the communication initiated via the site. Also, the dissociation of the communication between first and second node from the third node enables the third node operator and/or operator of the database to be impartial with respect to any communication between the first node and the second node. This in turn enables holders of IPR willing to sell or license their IPR to provide IPR information to the database. This in turn, makes it more likely for a potential buyer with a well defined need to find an IPR in the database. Thus, viewing the contents of the database is attractive to a wider audience, which in turn makes it more attractive for IPR holders to use the site for offering their IPR on the site.

The Internet platform in an embodiment according to the invention aims to fill the gap between potential sellers of Intellectual Property Rights (IPR), in particular patents and trademarks, and potential buyers. In an embodiment a potential buyer can view IPRs listed on a website as being available for sale or license, then turn to a point of contact indicated in the list in association with the IPR of interest, and negotiate a deal involving the IPR of interest. The Internet platform may remove barriers between patent owners and potential buyers. Thus, the Internet platform may dramatically enhance the likelihood of deals being done.

Sometimes, patent owners need low costs. In an embodiment the Internet platform achieves low costs by charging patent owners only a marginal return, for example, an administrative charge for entering the IPR in the platform's IPR list and for keeping it listed. In an embodiment the Internet platform generates further income by charging providers of IPR-related services for advertising their services on the site. In an embodiment the Internet platform operator operates the Internet platform as a place for an owner of IPR to advertise the IPR's availability for sale or for licensing and as place for a provider of services related to IPR to advertise the availability of such services. The Internet platform operator offers to the user to view the advertisements in order to use the viewed information to pursue an interest in an acquisition of, or to take a license to, the IPR shown to be available for sale or licensing, respectively, and to use the advertised services.

In an embodiment the Internet platform operator solicits information about intellectual property rights that a user as owner of an Intellectual Property Right or Industrial Property Right (herein collectively IPR), or its authorized representative, seeks to sell or to license (herein also called IPR information). In an embodiment the Internet platform operator requires the user or the third party that provides IPR information (herein in this respect collectively the IPR information provider) to also provide IPR information provider's contact details (herein also called the contact information). Such contact information may serve to address to the IPR information provider any future enquiries related to IPR information (herein also called contact information). In an embodiment the Internet platform operator prepares for display on the platform, based on the IPR information, data related to selected IPR.

In an embodiment, the Internet platform operator uploads the prepared information together with the necessary and/or approved contact information (herein also called display information) to the Internet platform and may display the display information on the Internet platform as information related to IPR that, as the case may be, is on offer for sale or licensing. The user may view the display information and use the IPR information as a starting point for further investigation into the IPR, for example in public data bases, so as to select IPR of the user's interest. The user may use the contact information in order to direct an enquiry related to the selected IPR to a contact address associated with the selected IPR.

At least one effect of embodiments described herein may be that the Internet platform operator does not need to become party of any contractual relationship between the users of the services, respectively the owner of IPR as a potential seller or licensor and the potential purchaser or licensee of the respective IPR. In an embodiment the Internet platform operator may not need to broker the IPR, i.e., the Internet platform operator may not engage in negotiations between an IPR information provider and the user related to any of the IPR. In one embodiment a user who seeks such brokerage services or other IPR-related services, in an embodiment particularly induced by the IPR listed on the platform, could, for example, turn to a suitable one of the service providers that advertise services related to intellectual property on the platform.

An embodiment described herein provides a method of establishing communication in a network between a seller of an Intellectual Property Right (IPR) using a first node at a first address, and a buyer of the IPR using a second node at a second address. The method comprises, in a memory coupled to a third node at a third address, providing a database. The database is to comprise an identifier to identify the IPR and the first address associated with the identifier. The method further includes transmitting the identifier and the first address from the third node to the second node. The method further includes transmitting a message including said second address from the second node to the first node, the message to indicate interest in the IPR. The method comprises receiving the message at said first node and, in response to the interest, opening a communication between the first node and the second node.

An embodiment further comprises, in a terminal coupled to the second node, building a list including IPR information conforming to the identifier and address information conforming to the first address. Arranging may include sorting, grouping and/or selecting IPR information comprised in data records provided from the data base. The arranging may be according to data fields in data records.

An embodiment includes providing a terminal software stored in the memory, the terminal software may comprise instructions that when executed cause a terminal, for example coupled to the second node, to perform the building of the list. The software may comprise instructions that when executed cause, in particular upon transmit request received at the third node, transmission of the terminal software to the second node for execution in the terminal.

In one aspect an embodiment encompasses a network. The network may be used for establishing communication between a seller of an IPR and a buyer of said IPR. In an embodiment the network may used for initiating the communication. In an embodiment the network may also be used for conducting the communication. The network comprises a first node at a first address. The first node may be associated with the seller. The network further comprises a second node at a second address. The second node may be associated with the buyer. The network further comprises a third node. The third node may be associated with an operator of a database and/or may be coupled to the database. In an embodiment the database is to comprise an identifier to identify the IPR and the first address associated with the identifier. In an embodiment the second node is to request the third node to transmit the identifier and the first address. In an embodiment the second node is to select the identified IPR as of interest and to transmit a message based on the identifier and/or including the second address to the first node to indicate interest in the identified IPR and request communication related to the identified IPR. The first node is to receive the message from the second node. In an embodiment the first node, in particular in response to the received message, may establish communication between the first node and the second node. At least one effect may be that potential buyer at the first node and seller at the second node may negotiate a deal without any participation of any database operator at the third node. Thus, the potential buyer need not suspect any bias in the IPR information presented on the platform, i.e., for example, as transmitted from the third node to the second node. Another effect may be that the seller need not pay the platform operator for any brokerage services so that a small price may suffice making, in turn, viewing the platform more attractive to the buyer, the platform thus attracting more buyers which, in turn, induces more sellers to use the platform to offer their IPR. In sum, the effect may be establishment of a marketplace for IPR, thus enabling patentees hitherto barred from reaping the fruit of their patent to amortise their investment, inducing such patentees to invest more and create inventions which is to the benefit of the people in general. An embodiment further comprises a terminal coupled to said second node, the terminal to build a list including IPR information conforming to said identifier and address information conforming to said first address. In an embodiment the IPR information in the list is at least one of: (i) selected based on the identifier; (ii) sorted based on the identifier, and (iii) grouped based on the identifier.

In one aspect an embodiment encompasses a server node for use in a network for establishing communication between a seller of an IPR, the seller using a first node at a first address, and a buyer of said IPR, the buyer using a second node at a second address, wherein said server node is at a third address, and wherein said server node is coupled to a memory holding a database, said database comprising an identifier to identify said IPR and, associated with said identifier, said first address. In an embodiment the server node is to receive a request message from said second node, and, responsive to said request message, is to provide, from said database, said identifier and said first address associated with said identifier for transmission to said second node. In an embodiment the server node is to provide from said database, said category information associated with said identifier for transmission to said second node. In an embodiment the request message includes a category request, and wherein said server node, for providing said identifier to said second node, is to select from said database said identifier based on said associated category information conforming to said category request. In an embodiment the server node has a software comprising instructions that when executed on a terminal cause the terminal to build a list comprising IPR information associated with said identifier and said first address, said server node providing said software for transmission to said second node.

In a one aspect an embodiment encompasses a software to be executed on a server node in a system for establishing communication between a seller of an IPR using a first node at a first address and a buyer of said IPR using a second node at a second address, the server node being at a third address, and the server node being coupled to a memory holding a database, the software comprising instructions that when executed cause the server node to enter into said database an identifier to identify said IPR, and said first address associated with said identifier; the server node further to provide, from said database, said identifier and said first address associated with said identifier for transmission to said second node. In an embodiment the software further comprises instructions that when executed cause to condition said providing said identifier and said first address on receiving a request message from said second node. In an embodiment the software further comprises instructions that when executed cause the server node to enter into said database category information associated with said identifier. In an embodiment the category information with respect to said IPR identified by said identifier is indicative of one or more selected from a group comprising: (i) availability for purchase, (ii) availability for license, (iii) family, (iv) owner, (v) associated portfolio, (vi) technical field, (vii) International Patent Class (IPC), and (viii) Nice class. In an embodiment the software further comprises instructions that when executed cause the server to provide, from said database, said category information associated with said identifier for transmission to said second node. In an embodiment the software further comprises instructions that when executed cause, if said request message includes a category request, said server node, for providing said identifier to said second node, to select from said database said identifier based on said associated category information conforming to said category request.

In one aspect an embodiment encompasses a terminal software to be executed on a terminal in a system. The system includes a first node at a first address and a second node at a second address. The terminal is coupled to the second node. The system further includes a server node at a third address. A memory is coupled to the third node. The memory holds a database. The database comprises an identifier to identify at least one IPR and the first address associated with the identifier. The software comprises instructions that when executed cause the terminal to transmit, from the second node to the third node, a request message requesting to transmit, from the third node to the second node, the identifier and the first address associated with the identifier. In an embodiment the terminal software further comprises instructions that when executed cause said terminal to build a list including IPR information conforming to the identifier and address information conforming to the first address. In an embodiment the terminal software further comprises instructions that when executed cause the building of the list such that IPR information in the list is at least one of: (i) selected based on the identifier; (ii) sorted based on the identifier, and (iii) grouped based on the identifier. In an embodiment the terminal software further comprises instructions that when executed cause the terminal to transmit from the second node to the third node a category request. In an embodiment the terminal software further comprises instructions that when executed cause the terminal to ignore the identifier unless the identifier is associated with category information conforming to the category request. In an embodiment the terminal software comprises instructions that when executed cause the terminal to arrange the identifier of the identified IPR in a list. In an embodiment the arranging includes at least one of: (i) sorting the identifier, (ii) grouping the identifier, and (iii) selecting the identifier. In an embodiment the terminal software comprises instructions that when executed cause the terminal to transmit a communication request from said second node to said first node, wherein said communication request includes said second address. In an embodiment the communication request includes said identifier and is indicative of interest in said identified IPR. In an embodiment the terminal software comprises instructions that when executed cause the terminal to initiate communication between the second node and the first node to agree upon a sale and/or license of the identified IPR.

In one aspect an embodiment encompasses a server software to be executed on a server in a network, the network comprising a first node at a first address, a second node at a second address, and a terminal coupled to said second node, a server node at a third address. The server node is coupled to a first memory holding a database. The database is to comprise an identifier to identify at least one IPR, and further to comprise the first address associated with the identifier. The server node is further coupled to a second memory holding a terminal software comprising instructions that when executed cause the terminal to transmit, using said second node, to the third node a request message requesting to transmit to the second node the identifier and the first address associated with the identifier. The server software comprises instructions that, when executed cause the server node, to provide the terminal software from the second memory to the server node for transmission to the second node. In an embodiment the server software comprises instructions that when executed cause the server node to select from the database the identifier and the associated first address based on a selection criteria included in the request message. In an embodiment the server software further comprises instructions that when executed cause the server to provide, from the database, the category information associated with the identifier for transmission to the second node. In an embodiment the server software further comprises instructions that when executed cause, if the request message includes a category request, the server node, for providing the identifier to the second node, to select from the database the identifier based on the associated category information conforming to the category request.

In one aspect an embodiment encompasses a server software to be executed on a server node in a network. The network is to comprise a first node at a first address and a second node at a second address. A terminal may be coupled to the second node. The network is further to comprise a server node at a third address. The server is to be coupled to a first memory holding a database. The database is to comprise an identifier to identify at least one IPR, and further to comprise the first address associated with the identifier. The server node is further to be coupled to a second memory holding a terminal software comprising instructions that when executed cause said terminal to transmit, using the second node, to the third node a request message requesting to transmit to the second node the identifier and the first address associated with said identifier. The server software comprises instructions that when executed cause said server node to provide the terminal software from the second memory to the server node for transmission to the second node.

In one aspect an embodiment encompasses a computer-readable medium containing instructions for controlling a server node in a network. The network is to comprise a first node at a first address and a second node at a second address. A terminal is to be coupled to the second node. The network is further to comprise a server node at a third address. The server node is to be coupled to a first memory holding a database. The database is to comprise an identifier to identify at least one IPR, and further to comprise the first address associated with the identifier. The server node is further to be coupled to a second memory holding a terminal software comprising instructions that when executed cause the terminal to transmit, using the second node, to the third node a request message requesting to transmit to the second node the identifier and the first address associated with the identifier. The server software comprises instructions that when executed cause the server node to provide the terminal software from the second memory to the server node for transmission to the second node. In an embodiment the server software comprises instructions that when executed cause the server node to select from the database the identifier and the associated first address based on a selection criteria included in the request message. In an embodiment the server software further comprises instructions that when executed cause the server node to enter into the database category information associated with the identifier. The server software may further comprise instructions that when executed cause the server to provide, from the database, the category information associated with the identifier for transmission to the second node. In an embodiment the server software further comprises instructions that when executed cause, if the request message includes a category request, the server node, for providing the identifier to the second node, to select from the database the identifier based on the associated category information conforming to the category request.

In one aspect the embodiment encompasses a method of establishing communication in a network between a seller using a first node at a first address, and a buyer using a second node at a second address. The method comprises, in a first memory coupled to a third node at a third address, providing a database comprising a plurality of identifiers each to identify a property right. In a second memory coupled to the third node, storing at least one first address associated with said identifier. The method includes defining at least one first selection criterion to select a set of identifiers in the plurality of identifiers and transmitting the set of identifiers and associated first address from the third node to said second node. The method includes transmitting a message from said second node to said first address. The message includes at least one selected identifier and said second address. The at least one selected identifier is selected from said set of identifiers. The method includes receiving the message at said first node and, in response to the interest, opening a communication between the first node and the second node. In an embodiment the defining includes, in particular at said second node, defining at least one search term. In an embodiment the method includes listing said set of identifiers at said second node. In an embodiment the listing includes defining a filter criteria and filtering the set of identifiers in accordance with said filter criteria. In an embodiment the property right is an intellectual property right.

In one aspect an embodiment encompasses a server software to be executed on a server node in a system for establishing communication between a seller of an intellectual property right (IPR) using a first node at a first address and a buyer of said IPR using a second node at a second address. The server node is at a third address. The server node is coupled to a first memory holding a set of identifiers. The server node is further coupled to a second memory holding at least one address associated with at least one identifier. The server software comprises instructions that when executed cause one or more processors to perform operations for the server node to receive at least one first selection criterion to select a set of identifiers in the plurality of identifiers, the server node to retrieve the set of identifiers from the first memory and to retrieve the associated first address from the second memory, and the server node to initiate transmission of said set of identifiers and associated first address from said third node to said second node.

In one aspect the server node is further coupled to a third memory storing a terminal software including instructions that when executed on one or more processors cause listing of said identifiers and associated first address. The server software comprises instructions that when executed cause one or more processors to perform operations for the server node to retrieve said terminal software from the third memory and transmit the terminal software to the second node.

In one aspect an embodiment encompasses a computer-readable medium containing instructions for controlling a server node in a network. The network is to comprise a first node at a first address, a second node at a second address, and a terminal coupled to said second node. Further the network is to comprise the said server node at a third address, wherein the server node is to be coupled to a first memory holding a database, and wherein the database is to comprise a plurality of identifiers each to identify an IPR, and further is to comprise the first address associated with the identifier, and the server node further to be coupled to a second memory holding a terminal software comprising instructions that when executed cause said terminal to transmit, using the second node, to the third node a request message including a criterion and requesting to transmit to the second node a selection of identifiers and the first address associated with the identifier, wherein the selection is in accordance with said criterion. The server software comprises instructions that when executed cause one or more processors in the server node to provide the terminal software from the second memory to the server node for transmission to the second node. In an embodiment the server software comprises instructions for the server node to select from the database the identifier based on the criterion. In an embodiment the server software further comprises instructions for the server node to enter into the database category information associated with the identifier. In an embodiment of the computer-readable medium according to the embodiment in the ninth aspect, the server software further comprises instructions for the server to provide, from the database, the category information associated with the identifier for transmission to the second node. In an embodiment the criterion is a category.

In one aspect an embodiment encompasses a terminal software for use in an IPR database session, the terminal software including instructions that when executed on one or more processors cause, at said terminal, listing of identifiers each associated with an IPR selected from a database coupled to said server, wherein the list comprises an address associated with said identifier. An embodiment of the terminal software further includes instructions that when executed cause transmitting a message from the terminal to the first address. The message includes at least one selected identifier and the second address. In an embodiment the at least one selected identifier is selected from the set of identifiers.

In one aspect an embodiment encompasses a computer-readable medium containing instructions for controlling a terminal in a network, the network to comprise a correspondent node at a first address, a terminal node at a second address and a server node at a third address. The terminal is to be coupled to the terminal node. The server node is to be coupled to a first memory holding a database. The database is to comprise a plurality of identifiers each to identify an IPR. The database is further to comprise the first address associated with the identifier. The terminal software comprises instructions that when executed cause one or more processors in the terminal to transmit, using said second node, to the server node a request message including a criterion and requesting to transmit to the terminal node a selection of identifiers and the first address associated with the identifier. The selection is in accordance with the criterion. In an embodiment the terminal software comprises instructions for the terminal node to build a list including one or more of said selection of said identifiers and associated address. In an embodiment the terminal software further comprises instructions for said list to include category information associated with said identifier and to be filtered according to category.

In one aspect, the invention encompasses a method of establishing communication in a network between a computer node at a first address, and a client node at a second address. The method comprises, coupled to a server node at a third address, providing a database comprising a plurality of identifiers each to identify at least one unique item and said first address associated with said identifier; transmitting said identifier and said first address from said server node to said client node; and transmitting a message from said client node to said computer node. In an embodiment the message includes a reference to at least one in the group comprising: (i) said third address, (ii) said server at said third address, (iii) said identifier, (iv) said unique item associated with said identifier, (v) a characteristic of said unique item associated with said identifier, and (vi) said server. An embodiment further includes receiving said message at said first node, and opening a communication between said first node and said second node. In an embodiment the method further includes pre-selecting a set of identifiers in the database, wherein transmitting said identifier includes transmitting said pre-selected set of identifiers. An embodiment further comprises transmitting a pre-selection criterion from said computer node to said server node, and using said pre-selection criterion in pre-selecting said set of identifiers. In an embodiment the identifier comprises at least one selected from a group consisting of: (i) an application number, (ii) an application date, (iii) a country and/or office of application, (iv) an registration number, (v) a registration date, (vi) a country and/or office of registration, (vii) a publication number. An embodiment comprises, at said client node, outputting information associated with said identifiers in said pre-selected set of identifiers. Yet another embodiment of the method comprises, at said client node, in said pre-selected set of identifiers, selecting a subset of identifiers, and building a list including said information conforming to said subset of selected identifiers and address information conforming to said first address. An embodiment further comprises arranging said list, wherein said arranging includes at least one of: (i) sorting according to said IPR information, (ii) grouping according to said identifier, and (iii) selecting according to said IPR information. An embodiment further comprises providing in said database flag information associated with said identifier, said flag information to indicate at least one of a group consisting of: (i) availability for purchase, (ii) availability for license, (iii) family of IPR, (iv) owner of IPR, (v) associated IPR portfolio. In an embodiment the list is to include said flag information. In an embodiment the arranging includes at least one of: (i) sorting according to said flag information, (ii) grouping according to said flag information, and (iii) selecting according to said flag information. An embodiment further includes providing in said database class information associated with said identifier. In an embodiment the criterion includes a classifier. In the embodiment, he method comprises comparing said class information with said classifier, and the message further comprises selecting said identifier and said first address for transmission to said second node, if said class information conforms to said classifier. In an embodiment the method includes providing a terminal software in a memory coupled to said server, said software comprising instructions that when executed cause a terminal coupled to said terminal node to perform said building of said list, and, upon transmit request received at said third node, to transmit said software to said second node for execution in said terminal. In an embodiment the unique item is an intellectual property right.

In one aspect an apparatus is disclosed, the apparatus to enable establishing communication in a network between a computer node at a first address, and a client node at a second address, the apparatus being coupled to a server node at a third address, wherein the apparatus controls a database comprising a plurality of identifiers each to identify at least one unique item and said first address associated with said identifier. In an embodiment the apparatus is configured to transmit said identifier and said first address from said server node to said client node. In one embodiment the apparatus is configured to perform pre-selecting a set of identifiers in said database, wherein transmitting said identifier includes transmitting said pre-selected set of identifiers. In one embodiment the apparatus is further configured to receive a pre-selection criterion from said computer node. In one embodiment the apparatus uses the pre-selection criterion in pre-selecting said set of identifiers. In one embodiment the criterion includes a classifier. In one embodiment the method comprises comparing the class information with the classifier. In one embodiment the method further comprises selecting said identifier and said first address for transmission to said second node, if said class information conforms to said classifier. In an embodiment the apparatus is coupled to a storage medium, for example a memory, storing a terminal software. The terminal software comprises instructions that when executed cause a terminal coupled to said terminal node to perform the building of the list for selection of unique items, the list having address information associated with the identifier and other information associated with said identifier and/or the identifier itself. In an embodiment the apparatus may further be configured to transmit, upon transmit request received at said third node, the software to the second node for execution in the terminal. In an embodiment the unique item is an intellectual property right. The identifier can comprise at least one selected from a group consisting of: (i) an application number, (ii) an application date, (iii) a country and/or office of application, (iv) an registration number, (v) a registration date, (vi) a country and/or office of registration, (vii) a publication number.

In one aspect an apparatus to enable establishing communication in a network between a computer node at a first address and a client node at a second address is disclosed. The apparatus is coupled to a server node at a third address. The apparatus can control a database comprising a plurality of identifiers each to identify at least one unique item and said first address associated with said identifier. In one embodiment the apparatus is configured to transmit the identifier and the first address from said server node to the client node. In one embodiment the apparatus is configured to enable pre-selecting a set of identifiers in the database, the set herein also being also referred to as “pre-selected set”. In an embodiment transmitting the identifier includes transmitting said pre-selected set of identifiers. In one embodiment the apparatus is further configured to receive a pre-selection criterion from the computer node for use in the pre-selecting the set of identifiers. In one embodiment the criterion includes a classifier. The method comprises comparing class information with the classifier. The method further comprises pre-selecting the identifier and the first address for transmission to the second node, if the class information associated with the identifier conforms to the classifier. In an embodiment is coupled to a storage medium storing a terminal software. The terminal software comprises instructions that when executed cause a terminal coupled to the terminal node to perform the building of a list for a pre-selection of unique items, address information associated with the identifier and other information associated with the identifier, and/or the identifier itself. In an embodiment the apparatus is further configured to transmit, upon transmit request received at the third node, the software to the second node for execution in the terminal. In one embodiment the unique item is an intellectual property right. In one embodiment the identifier comprises at least one selected from a group consisting of: (i) an application number, (ii) an application date, (iii) a country and/or office of application, (iv) an registration number, (v) a registration date, (vi) a country and/or office of registration, (vii) a publication number.

In one aspect a method of establishing communication in a network between a seller of an IPR using a first node at a first address and a buyer of said IPR using a second node at a second address is disclosed. The method comprises, in a storage medium coupled to a third node at a third address, providing a database comprising an identifier to identify the IPR and the first address associated with said identifier, and transmitting the identifier and the first address from said third node to the second node. In one embodiment the method further comprises transmitting a message from the second node to the first node, the message to indicate interest in the IPR and the message including the identifier and the second address. The message may in one embodiment be received at said first node. In an embodiment the method comprises, responsive to the interest, opening a communication between said first node and said second node. In an embodiment the identifier comprises at least one selected from a group consisting of: (i) an application number, (ii) an application date, (iii) a country and/or office of application, (iv) an registration number, (v) a registration date, (vi) a country and/or office of registration, (vii) a publication number. For example, the identifier may be formed as a combination of (i) the application number, (ii) the application date, (iii) the country and/or office of application. One embodiment further comprises, in a terminal coupled to said second node, building a list including IPR information conforming to said identifier and address information conforming to said first address. In one embodiment arranging includes at least one of: (i) sorting according to said IPR information, (ii) grouping according to said identifier, and (iii) selecting according to said IPR information. An embodiment comprises providing, in the database, flag information associated with the identifier. The flag information can be to indicate at least one of a group consisting of: (i) availability for purchase, (ii) availability for license, (iii) family of IPR, (iv) owner of IPR, (v) associated IPR portfolio. In an embodiment the list is to include said flag information. In an embodiment the arranging includes at least one of: (i) sorting according to the flag information, (ii) grouping according to the flag information, and (iii) selecting according to the flag information. An embodiment further comprises providing, in the database, class information associated with the identifier. The message includes a classifier, the method comprises comparing the class information with the classifier, and the message further comprises selecting the identifier and the first address for transmission to the second node, if the class information conforms to said classifier. The method includes providing a terminal software in the storage medium, the software comprising instructions that when executed cause a terminal coupled to the second node to perform said building of the list, and, upon transmit request received at said third node, to transmit said software to said second node for execution in said terminal.

In an embodiment the price information is variable and further comprising measuring fine-selection of said identifier associated with said price information. Measuring fine-selection of the identifier associated with said price information may, for example, take place by counting a number of “clicks” on an attribute information of the associated IPR within a fixed time interval, by counting a time lapsed between a first such click and a second such click, and other.

In an embodiment price information is varied based on said measuring of said fine-selection. Price information can be optimised to enhance a prospect of seller finding a buyer at a price above reservation price, wherein seller may, in light of measurement results of fine-selection, adapt the reservation price.

The terminal is not meant to be limited to hardware. A terminal herein can be browser, tab in a browser or other function for output of data to a user and for receiving user input of data.

An example of external attribute information may be a status of a patent application having resulted in a patent grant. The external attribute information associated with said identifiers enables to include up-to-date attribute information in the list. External attribute information does not need to be kept under the control of the server operator. The server operator may relieve itself of the task to update the external attribute information. The external attribute information may, for example, be kept in a public database accessible at the fourth node under a link associated with said link information. Thus, a server operator can keep the database controlled by the server lean. Further, a user at the second node can avoid loading unnecessary information for listing, since by including link information in the list, the user is given a choice to use such link information to request and/or access external information.

An example of other external information may be a data file representing a patent publication, such as a PDF file of the granted patent. For example, FIG. 6 shows an implementation where a document opened by a user at the second node, the user using a link comprised in the list, to download the document “Offenlegungsschrift” from a third party database coupled to the Internet.

Exemplary implementations discussed herein may have various components collocated; however, it is to be appreciated that the various components of the arrangement may be located at distant portions of a distributed network, such as a communications network and/or the Internet, or within a dedicated secure, unsecured and/or encrypted arrangement. Thus, it should be appreciated that the components of the arrangements may be combined into one or more apparatuses or collocated on a particular node of a distributed network, such as a telecommunications network. Moreover, it should be understood that the components of the described arrangements may be arranged at any location within a distributed network without affecting the operation of the arrangements. Similarly, one or more functional portions of the arrangement may be distributed between a modem and an associated computing device.

The above-described implementations, arrangements, apparatuses and methods may be implemented in firmware, hardware, software, one or more software modules, one or more software and/or hardware testing modules, one or more telecommunications test devices, one or more xDSL modems, one or more linecards, one or more G.hn transceivers, one or more MOCA transceivers, one or more Homeplug transceivers, one or more powerline modems, one or more wired or wireless modems, one or more wired and/or wireless wide/local area network systems, one or more satellite communication systems, network-based communication systems (such as an IP, Ethernet or ATM system), or the like, or on one or more separate programmed general purpose computers.

Additionally, the implementations, arrangements, procedures and protocols of the described implementations may be implemented on a special purpose computer, a programmed microprocessor or microcontroller and peripheral integrated circuit element(s), a modem, a transmitter/receiver, any comparable device, or the like. In general, any apparatus capable of coupling to a communications line may be used to implement the various communication methods, protocols and techniques according to the implementations.

Furthermore, the disclosed implementations and procedures may be readily implemented in software using object or object-oriented software development environments that provide a portable source code that can be used on a variety of computer or workstation platforms. The communication arrangements, procedures and protocols described and illustrated herein may be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed procedures may be readily implemented in software that can be stored on a computer-readable storage medium, executed on a programmed general-purpose computer with the cooperation of a controller and memory, a special purpose computer, a microprocessor, or the like. In these instances, the arrangements and procedures of the described implementations may be implemented as a program embedded on a personal computer such as an applet, JAVA® or CGI script, as a resource residing on a server or computer workstation, as a routine embedded in a dedicated communication arrangement or arrangement component, or the like. The arrangements may also be implemented by physically incorporating the arrangements and/or procedures into a software and/or hardware system.

The implementations herein are described in terms of exemplary embodiments. However, it should be appreciated that individual aspects of the implantations may be separately claimed and one or more of the features of the various embodiments may be combined. In the above description of exemplary implementations, for purposes of explanation, specific numbers, materials configurations, and other details are set forth in order to better explain the invention, as claimed. However, it will be apparent to one skilled in the art that the claimed invention may be practiced using different details than the exemplary ones described herein. In other instances, well-known features are omitted or simplified to clarify the description of the exemplary implementations.

The inventors intend the described exemplary implementations to be primarily examples. The inventors do not intend these exemplary implementations to limit the scope of the appended claims. Rather, the inventor has contemplated that the claimed invention might also be embodied and implemented in other ways, in conjunction with other present or future technologies.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts and techniques in a concrete fashion. The term “techniques,” for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

The exemplary processes discussed herein are illustrated as a collection of blocks in a logical flow graph, which represents a sequence of operations that can be implemented with hardware, software, firmware, or some combination thereof. In the context of software/firmware, the blocks represent instructions stored in memory, i.e., on one or more processor-readable storage media that, when executed by one or more processors, perform the recited operations. The operations of the exemplary processes may be rendered in virtually any programming language or environment including (by way of example and not limitation): BASIC, C/C++, Fortran, COBOL, PASCAL, assembly language, markup languages (e.g., HTML, SGML, XML, VoXML), Javascript, and the like, as well as object-oriented environments such as the Common Object Request Broker Architecture (CORBA), Java™ (including J2ME, Java Beans, etc.), Binary Runtime Environment (BREW), and the like. Moreover, the described implementations may be similarly executed and realized by way of such hardware, software, firmware, or some combination thereof.

Note that the order in which the implementations and processes are described is not intended to be construed as a limitation, and any number of the described implementations and processes may be combined. Though the description of embodiments herein refers to intellectual property rights, the present invention should not be understood as limited to intellectual property rights. In embodiments according to the invention other unique items such as collector's items take the place of intellectual property rights.

The terms “memory” and “processor-readable media” include processor-storage media. For example, memory, i.e., processor-storage media may include, but are not limited to, magnetic storage devices (e.g., hard disk, floppy disk, and magnetic strips), optical disks (e.g., compact disk (CD) and digital versatile disk (DVD)), smart cards, flash memory devices (e.g., thumb drive, stick, key drive, and SD cards), and volatile and non-volatile memory (e.g., random access memory (RAM), read-only memory (ROM)).

For the purposes of this disclosure and the claims that follow, the terms “coupled” and “connected” may have been used to describe how various elements interface. Such described interfacing of various elements may be either direct or indirect.

What is claimed, is:

1. A method for establishing communication in a network between a seller of intellectual property rights using a first node at a first address, and a buyer of intellectual property rights using a second node at a second address, the method comprising:
using a third node at a third address to provide data comprising a plurality of identifiers each to identify an intellectual property right, attribute information associated with said intellectual property right, and at least one first address, each first address being associated with a at least one identifier in said plurality of identifiers;
determining a pre-selection criterion to pre-select a set of identifiers in the plurality of identifiers;
using said attribute information to pre-select a set of identifiers to form a pre-selected set of identifiers,
transmitting said pre-selected set of identifiers and first addresses associated with identifiers in the pre-selected set of identifiers from said third node to said second node;
in said pre-selected set of identifiers, fine-selecting at least one fine-selected identifier; and
generating a message for transmission from said second node to said first address associated with said fine-selected identifier, said message including said fine-selected identifier and said second address.

2. The method of claim 1, including transmitting said message from the second node, receiving said message at said first node; and opening a communication between said first node and said second node.

3. The method of claim 2, wherein providing data includes requesting attribute information from one or more information sources external to control by said third node and selected from the group consisting of: (i) an Internet-based telephone database, (ii) an Internet-based electronic mail database, (iii) a telephone database, (iv) an electronic mail database, (v) a database of previously collected information, (vi) an Internet-based search engine, (vii) a database of information relating to a domain name registration of an electronic mail address of the seller, (viii) a database of information relating to a domain name registration of an electronic mail address of the buyer.

4. The method of claim 1, wherein said determining said pre-selection criterion is performed at said second node and said pre-selection criterion is transmitted from said second node to said third node.

5. The method of claim 1, including constructing a list of said pre-selected set of identifiers at said second node for output to a viewer, said list including at least a portion of said attribute information associated with said identifiers in said pre-selected set of identifiers.

6. The method of claim 5, wherein said one or more information sources is controlled by a fourth node at a fourth address, said second node requesting attribute information associated with said identifiers from said fourth node in the network.

7. The method of claim 5, wherein said list includes link information associated with said identifier to enable requesting a fifth node in said network to provide information associated with said identifiers.

8. The method of claim 5, wherein outputting said list includes defining a filter criterion and filtering said pre-selected set of identifiers in accordance with said filter criterion.

9. The method of claim 1, wherein said identifier comprises at least one selected from a group consisting of: (i) an application number, (ii) an application date, (iii) a country and/or office of application, (iv) a registration number, (v) a registration date, (vi) a country and/or office of registration, (vii) a publication number, (viii) a database specific identification.

10. The method of claim 1, wherein said attribute information represents at least one attribute of said IPR identified by the identifier, the attribute information including at least one in a group consisting of: (a) flag information to indicate at least one of a group including but not limited to (i) availability for purchase, (ii) availability for license; (b) category information including at least one of a group including but not limited to (i) technical field of invention, (ii) use field of invention, (iii) associated portfolio; (c) class information including at least one of a group including but not limited to (i) International Patent Class, (ii) owner-defined patent class, (iii) Nice class; (d) owner information including at least one of a group including but not limited to (i) material owner, (ii) registered owner; (e) price information; (f) encumbrance information.

11. The method of claim 12, wherein said price information is variable, the method further comprising measuring fine-selection of said identifier associated with said price information.

12. The method of claim 11, the method including varying said price information based on said measuring of said fine-selection.

13. A computer-readable medium, comprising instructions for controlling execution of a server node task in a network, the network to comprise a first node associated with a first address, a second node associated with a second address, and said server node associated with a third address,
wherein said instructions when executed cause one or more processors in said server node to provide a software to said second node for the second node to interact with said server node so as to further provide a set of pre-selected identifiers, attribute information associated with identifiers in said set of pre-selected identifiers and address information both associated with said identifiers and with said first address.

14. The computer-readable medium of claim 13 comprising instructions for said server node to receive a criterion and to pre-select from said database said identifier based on attribute information associated with said identifier conforming to said criterion.

15. The computer-readable medium of claim 13, comprising instructions to request attribute information associated with said identifier from a fourth node in said network, wherein said fourth node is coupled to at least one of group consisting of (i) an Internet-based telephone database, (ii) an Internet-based electronic mail database, (iii) a local telephone database, (iv) a local electronic mail database, (v) a database of previously collected information, (vi) an Internet-based search engine, (vii) a database of information relating to the domain name registration of an electronic mail address of the seller of said IPR, and (viii) a database of information relating to the domain name registration of an electronic mail address of the buyer of said IPR.

16. The computer-readable medium of claim 13, further comprising instructions for controlling a terminal task in a terminal coupled to said second node,
said instructions to cause said second node to transmit a request message including a criterion to said third node, wherein said request message requests said third node to pre-select, based on said attribute information conforming to said criterion, a set of identifiers, and to transmit to said second node said set of pre-selected identifiers and said first address information associated both with said at least one identifier in said set of pre-selected identifiers and with said first node.

17. The computer-readable medium of claim 13, comprising instructions for said second node to build a list including one or more of said pre-selected identifiers, associated attribute information and associated address information, said list to be output to fine-select at least one identifier in said list and to send a message to said first address associated with said identifier, said message to include IPR information associated with said fine-selected identifier and said second address.

18. The computer-readable medium of claim 13, comprising instructions to receive a filter information and to filter said list to exclude identifiers from output where said filter information is excluded from information associated with said excluded identifiers.

19. An apparatus to enable establishing communication in a network between a first node at a first address, and a second node at a second address, the apparatus being coupled to a third node at a third address, wherein the apparatus controls a database comprising a plurality of identifiers each to identify at least one unique item and said first address associated with said identifier;
the apparatus being configured to transmit said identifier and said first address from said third node to said second node, and further configured to transmit instructions to said client node to build a list including one or more of said unique items, associated attribute information and associated address information, said list to be output to fine-select at least one unique item in said list and to send a message to said first address associated with said identifier, said message to include information associated with said fine-selected unique item and said second address.

20. The apparatus of claim 19, wherein the apparatus is configured to perform pre-selecting a set of identifiers in said database, wherein transmitting said identifier excludes transmitting other identifiers than said pre-selected set of identifiers.
